(19) United States
(12) Patent Application Publication
(10) Pub. No.: US 2023/0178848 A1
(43) Pub. Date: Jun. 8, 2023

(54) ELECTRODE SEPARATORS

(71) Applicant: King Abdullah University of Science and Technology, Thuwai (SA)

(72) Inventors: Jiangtao JIA, Thuwal (SA); Arijit MALLICK, Thuwal (SA); Osama SHEKHAH, Thuwal (SA); Mohamed EDDAOUDI, Thuwal (SA)

(21) Appl. No.: 17/922,233

(22) PCT Filed: Apr. 27, 2021
(86) PCT No.: PCT/IB2021/053481

§ 371 Date: Oct. 28, 2022

Related U.S. Application Data
(60) Provisional application No. 63/016,517, filed on Apr. 28, 2020.

(51) Int. Cl. H01M 50/414; H01M 10/0525; H01M 50/403

(52) U.S. Cl. CPC H01M 50/414; H01M 10/0525; H01M 50/403

(57) ABSTRACT

Embodiments of the present disclosure describe freestanding microporous membranes, methods of fabricating freestanding microporous membranes, freestanding porous membranes as electrode separators, electrochemical cells comprising freestanding porous membranes, and the like. In one aspect, the present invention provides an electrode separator comprising a freestanding microporous membrane including at least one of a covalent organic framework and a metal organic framework, and a threading polymer associated with the freestanding microporous membrane via one or more non-covalent interactions, wherein each of the threading polymer and freestanding microporous membrane include at least one moiety that participates in the one or more non-covalent interactions.

### BACKGROUND

Lithium ion batteries, such as lithium-sulfur batteries, are rechargeable batteries notable for their high energy capacities and are one of the most widely used batteries for energy storage. A typical electrochemical cell of a battery comprises a separator interposed between an anode and a cathode. In a lithium ion battery, metallic lithium is used as an anode material and, in the case of a lithium-sulfur battery, sulfur is used as a cathode material. The separator is usually a microporous polymeric membrane. During discharge, oxidation takes place at the anode, and reduction takes place at the cathode. Lithium ions generated during oxidation and reduction can migrate through an electrolyte which impregnates the pores of the separator.

The primary function of an electrode separator is to serve as an electrical insulator between a positive electrode and a negative electrode (for example, a cathode and an anode, respectively) to prevent migration of electrons from electrode to electrode through the separator, while allowing for migration of ionic charge carriers through the separator. The migration of ionic charge completes the electrical circuit, permitting passage of current from positive electrode to negative electrode in an electrochemical cell. The electrode separator should be chemically and electrolytically stable in electrolytic solution. It must have sufficient flexibility, while retaining mechanical strength at reduced thicknesses to endure high tension during manufacturing. These properties are important as they can affect battery performance, including battery energies and power densities, cycle life, and safety.

Microporous polymeric membranes are often used as separators in lithium ion batteries. Examples include polyolefins, such as polyethylene and polypropylene, glass fiber filter paper, and ceramic materials. Such materials, however, are limited in that the pore sizes can be 10 nm or larger and pore distribution can be inhomogeneous, thereby limiting their efficiency as separators. In addition, repeated charging and discharging of lithium ion batteries can lead to the growth of lithium-based dendrites that pierce polymeric membranes separating the anode from the cathode. While various other porous materials have been proposed as electrode separators, it remains an ongoing challenge to fabricate them as flexible freestanding membranes or thin films without defects or cracks.

### SUMMARY

In one aspect, the present invention provides an electrode separator comprising a freestanding microporous membrane including at least one of a covalent organic framework and a metal organic framework, and a threading polymer associated with the freestanding microporous membrane via one or more non-covalent interactions, wherein each of the threading polymer and freestanding microporous membrane include at least one moiety that participates in the one or more non-covalent interactions.

In another aspect, the present invention provides a method of making an electrode separator comprising mixing a monomer with a microporous source to form a precursor solution, heating the precursor solution to one or more select temperatures; depositing the precursor solution on a support; drying the precursor solution to obtain a supported microporous membrane; and delaminating the microporous membrane from the support to obtain an electrode separator, wherein the electrode separator comprises a freestanding microporous membrane including at least one of a covalent organic framework and a metal organic framework, and a threading polymer associated with the freestanding microporous membrane via one or more non-covalent interactions, wherein each of the threading polymer and freestanding microporous membrane include at least one moiety that participates in the one or more non-covalent interactions.

In a further aspect, the present invention provides an electrochemical cell comprising a first electrode, a second electrode, and an electrode separator disposed between the first electrode and the second electrode, wherein the electrode separator comprises a freestanding microporous membrane including at least one of a covalent organic framework and a metal organic framework, and a threading polymer associated with the freestanding microporous membrane via one or more non-covalent interactions, wherein each of the threading polymer and freestanding microporous membrane include at least one moiety that participates in the one or more non-covalent interactions.

The details of one or more examples are set forth in the description below. Other features, objects, and advantages will be apparent from the description and from the claims.

### BRIEF DESCRIPTION OF DRAWINGS

This written disclosure describes illustrative embodiments that are non-limiting and non-exhaustive. In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

Reference is made to illustrative embodiments that are depicted in the figures, in which:

FIG. 1A-1C are diagrams illustrating a lattice structure that can be built to create an electrode separator, according to one or more embodiments of the present disclosure.

FIG. 2 is a flowchart of a method of fabricating a membrane, according to one or more embodiments of the present disclosure.

FIG. 3 is a diagram illustrating a portion of a battery or an electrochemical cell, according to one or more embodiments of the present disclosure.

FIGS. 4A-4C are schematic diagrams of (A) a battery building up structure showing the location of the separator, (B) a separator as a freestanding thin film of a COF material, and (C) a chemical structure of the separator, according to one or more embodiments of the present disclosure.

FIG. 5 is a schematic diagram of a method of fabricating freestanding thin films of a COF membrane, according to one or more embodiments of the present disclosure.

FIGS. 6A-6D show (A) a schematic diagram of a membrane and (B) PXRD, (C) N₂ isotherm, and (D) CO₂ isotherm of the freestanding thin films of a COF material, according to one or more embodiments of the present disclosure.

FIGS. 7A-7C are (A-B) SEM images and (C) a graphical view of EDX analysis of a COF freestanding membrane, according to one or more embodiments of the present disclosure.

FIGS. 8A-B show a schematic diagram (A) of a synthetic scheme and structure of a Zr-NDC-SO₃H fcu MOF, and (B) PXRD patterns of the simulated and experimental Zr-NDC-SO₃H fcu MOF, according to one or more embodiments of the present disclosure.

FIG. 9 shows cycling performance at the current density of 0.05 A/g for the Zr-NDC-SO₃H fcu MOF separator and the bare commercial separator, according to one or more embodiments of the present disclosure.

### DETAILED DESCRIPTION

### Definitions

The terms recited below have been defined as described below. All other terms and phrases in this disclosure shall be construed according to their ordinary meaning as understood by one of skill in the art.

As used herein, the term “microporous material” refers to and/or includes materials such as Porous Organic Polymers (POP), Covalent-Organic Frameworks (COF), Porous Aromatic Frameworks (PAF), Porous Polymer Networks (PPN), Conjugated Microporous Polymers (CMP), Microporous Polymer Networks (MPN), Polymers with Intrinsic Microporosity (PIM), Hyper Crossed-linked Polymers (HCP), Metal-organic Frameworks (MOF), Metal-organic Polyhedrons (MOPs), Coordination Polymers (CP), Porous Coordination Polymers (PCP), Porous Coordination Networks (PCN), Metal-Organic Materials (MOM), and the like. The term includes crystalline microporous materials, such as covalent organic frameworks and metal organic frameworks, among other microporous materials. Microporous materials can optionally further include one or more of wettable material coatings, polymers, gels, or fillers, such as, inorganic particles, biopolymers, polysaccharides, celluloses, dextrins, cyclodextrins, dextrans, silicates, and nanoparticles.

Metal-organic materials (MOMs) and coordination polymers (CPs) refer to a large family of solids characterized by the nature of coordination bonding between metal ions and organic linkers. The metal ions can include alkali metals, rare-earth metals, transition metals, lanthanides, or post-transition metals. Organic linkers can include any organic molecule capable of forming a coordination or ionic bond to metal ions. Organic linkers generally possess functional groups like carboxylic acids, amines, azoles, oxazoles, thiols, thiazoles and other heteroatoms or groups capable of bonding to a metal ion. MOMs and CPs can exhibit various structures ranging from discrete supermolecules (known also as metal-organic polyhedra, MOPs) to chains to layers and sheets to 3D structures. MOMs and CPs can exhibit permanent porosity as indicated by reversible gas sorption isotherms and/or reversible guest exchange behavior.

MOFs are a class of crystalline porous materials comprising metal ions or metal clusters coordinated to multidentate organic linkers or ligands to form one-, two-, or three-dimensional structures, with periodic open frameworks. MOFs are considered to be MOMs. The framework topology, pore size, and surface area, among other characteristics, can be easily tuned by the selection of molecular building blocks or secondary building units, among other things. Examples of MOFs are described in U.S. Pat. Nos. 10,201,803, 8,123,834, 8,034,952, 7,880,026, 7,582,798, 7,279,517, 7,196,210, 6,929,679, 6,930,193, 6,893,564, and 6,624,318, each of which is hereby incorporated by reference in its entirety. Other examples of suitable porous materials are described in T. Kundu, et al., ChemComm 2012, DOI: 10.1039/c2cc31135f, which is hereby incorporated by reference in its entirety.

COFs typically comprise a plurality of cores covalently bonded to linking moieties to form two- or three-dimensional crystalline materials. For example, organic monomers comprising light elements (e.g., B, C, N, O, P, etc.) can be linked via strong covalent bonds in a periodic manner to form such extended structures. The organic monomers can have functional groups like carboxylic acids, amines, azoles, oxazoles, thiols, thiazoles, terminal alkynes, halogenated aromatics like iodo/bromo benzenes, boronic acids, aldehydes, amides, and acyl halides, among other functional groups. Covalent-organic frameworks are typically synthesized and subsequently crystallized by means of reversible condensation reactions/covalent bond formation reactions like boronic acid trimerisation, boronate ester formation and Schiff base reaction, among others. Structurally, COFs are closely related to metal-organic frameworks (MOFs). For example, COFs can exhibit various structures ranging from discrete supermolecules to chains to layers and sheets to 3D structures. COFs can exhibit permanent porosity as indicated by reversible gas sorption isotherms and/or reversible guest exchange behavior. Examples of covalent-organic frameworks are provided in U.S. Pat. Nos. 9,499,555B2 and 9,269,473B2, each of which is hereby incorporated by reference in their entirety.

As used herein, the term “moiety” in the singular tense refers to a chemical class in which all chemical groups belonging to the class have at least one of the following: the same chemical structure, the same chemical formula, and the same or similar point(s) of attachment throughout a larger structure. For example, a polymer can include a plurality of —OH groups, each —OH group being attached to the same carbon atom in each repeating monomer unit of the polymer. In this example, the term hydroxyl moiety, although singular in tense, refers to and includes all —OH groups having the same point of attachment in each repeat monomer unit of the polymer. In the plural tense, the term refers to at least two chemical groups, each chemical group having at least one of the following: a different chemical formula, a different chemical structure, a different point(s) of attachment. For example, a polymer can include a first —OH group attached to a first carbon atom and a second —OH group attached to a second carbon atom in each repeating monomer unit of the polymer. In this example, the term hydroxyl moieties refers to a first hydroxyl moiety and a second hydroxyl moiety, wherein the first hydroxyl moiety includes all first —OH groups attached to the first carbon atom in each repeat monomer unit of the polymer and the second hydroxyl moiety includes all second —OH groups attached to the second carbon atom in each repeat monomer unit of the polymer.

As used herein, the term “non-covalent interaction” refers to intermolecular interaction among two or more separate moieties which does not involve a covalent bond. Intermolecular interaction is dependent upon a variety of factors, including, for example, the polarity of the involved molecules, and the charge (positive or negative), if any, of the involved molecules. Non-covalent associations include ionic interactions, electrostatic dipole-dipole interactions, hydrogen bonding, van der Waal's forces, and combinations thereof. In contrast, the term “covalent association” refers to an intermolecular association or bond which involves the sharing of electrons in the bonding orbitals of two atoms.

As used herein, the term “electrostatic dipole-dipole interaction” generally refers to an intermolecular force between at least two molecules, each with permanent dipoles. For example, an electrostatic dipole-dipole interaction can be formed between a partial positive end of a first polar functional group or heteroatom, commonly designated as δ⁺, and a partial negative end of a second polar functional group or heteroatom, commonly designated as δ⁻. In the context of the present disclosure, the term typically refers to intermolecular forces of attraction; however, in the general sense and in some instances herein, the term may also include intermolecular forces of repulsion. In the context of intermolecular dipole-dipole interactions, the first and second polar functional groups or heteroatoms are each on separate molecules; whereas in the context of an intramolecular dipole-dipole interaction, both are on the same molecule.

As used herein, the term “polar functional group” or “polar moiety” refers to any functional group or moiety having a permanent dipole. The permanent dipole of a functional group or molecule can arise from differences in electronegativity between atoms which creates a permanent charge separation. Polar functional groups or moieties are examples of species that can participate in electrostatic dipole-dipole interactions, among other non-covalent interactions. Examples of polar functional groups include, but are not limited to, hydroxyl, carboxyl, carbonyl, ester, ether, amine, thiol, halogen, sulfone, phosphate, sulfonamide, carbonate, and the like. Examples of suitable heteroatoms include, but are not limited to, nitrogen, oxygen, sulfur, and the like.

As used herein, the terms “hydrogen bond” and “hydrogen bonding” refer to an attractive force in which a bond formed between a hydrogen atom covalently bonded to an electronegative atom (e.g., oxygen, sulfur, nitrogen, etc.) or group and another electronegative atom which can optionally bear one or two lone pairs of electrons. Alternatively, the hydrogen atom can be covalently bonded to an atom without the characteristic of being electronegative so long as that atom is bonded to an electronegative atom(s) or group(s). A hydrogen bond can be considered a type of electrostatic dipole-dipole interaction. In addition, a hydrogen bond can be intermolecular or intramolecular, although in the context of the present disclosure, hydrogen bonds are usually intermolecular.

As used herein, the terms “hydrogen bond donor” and “hydrogen bond donor moiety” refer to moieties containing at least one hydrogen atom capable of participating in the formation of a hydrogen bond and a more electronegative atom or group bound or covalently bonded to the hydrogen atom. The moiety C—H can also be a hydrogen-bond donor if the carbon atom is bound to another atom through a triple bond, if the carbon atom is bound through a double bond to O, or if the carbon atom is bound to at least one or at least two atoms selected from O, F, Cl, and Br. Non-limiting examples of such moieties include —O—H, —N—H, —P—H, —S—H, ≡C—H, —C(═O)—H, —C(E₁E₂)-H, where E₁ and E₂ are each independently selected from O, F, Cl, and Br. In some embodiments, a hydrogen bond donor moiety can form a hydrogen bond with two or more hydrogen bond acceptor moieties.

As used herein, the terms “hydrogen bond acceptor” and “hydrogen bond acceptor moiety” refers to moieties containing at least one electronegative atom, the at least one electronegative atom optionally bearing one or two lone pairs of electrons. The at least one electronegative atom is typically, but not necessarily, more electronegative than the hydrogen atom of the hydrogen bond donor. Non-limiting examples of such moieties include —C═O, —N—H, —N(H)—, —O—H, —C—F, —C(F)—, —P═O, —P(═O)—, —C≡N, —CO—, —C═N—, —C—NO₂, and —C—SO₃H. In some embodiments, a hydrogen bond acceptor moiety can form a hydrogen bond with two or more hydrogen bond donor moieties.

As used herein, the term “ionic interaction” refers to intermolecular interaction among two or more molecules, each of which is positively or negatively charged. Thus, for example, “ionic interaction” refers to the attraction between a first, positively charged molecule and a second, negatively charged molecule.

As used herein, the term “Van der Waal's forces” refers to the attractive forces between non-polar molecules that are accounted for by quantum mechanics. Van der Waal's forces are generally associated with momentary dipole moments which are induced by neighboring molecules and which involve changes in electron distribution.

As used herein, the term “crosslinking” and/or “crosslinking interaction” refers to the formation of linkages between polymers (e.g., polymer chains). The term includes forming covalent bonds and/or ionic bonds/interactions.

As used herein, “heteroatom” means an atom of any element other than carbon or hydrogen. Examples of heteroatoms include nitrogen, oxygen, boron, phosphorus, and sulfur. Heteroatoms may have hydrogen substituents and/or any permissible substituents of organic compounds described herein which satisfy the valences of the heteroatoms.

The term “aliphatic” when used without the “substituted” modifier signifies that the compound/group so modified is an acyclic or cyclic, but non-aromatic hydrocarbon compound or group. When the term is used with the “substituted” modifier one or more hydrogen atom has been independently replaced by any of the substituents disclosed herein.

As used herein, the term “alkyl” refers to a straight- or branched-chain or cyclic hydrocarbon radical or moiety comprising only carbon and hydrogen atoms, containing no unsaturation, and having 30 or fewer carbon atoms. The term “cycloalkyl” refers to aliphatic cyclic alkyls having 3 to 10 carbon atoms in single or multiple cyclic rings, preferably 5 to 6 carbon atoms in a single cyclic ring. Non-limiting examples of suitable alkyl groups include methyl group, ethyl group, propyl group, isopropyl group, cyclopropyl group, butyl group, isobutyl group, sec-butyl group, tert-butyl group, cyclobutyl group, pentyl group, neo-pentyl group, cyclopentyl group, hexyl group, cyclohexyl group, 2-ethylhexyl, cyclohexylmethyl group, heptyl group, octyl group, nonyl group, decyl group, dodecyl group, tridecyl group, tetradcyl group, pentadecyl group, hexadecyl group, heptadecyl group, octadecyl group, nonadecyl group, cyclopentyl group, cyclohexyl group, and the like. Additional examples of cycloalkyl groups include cyclopropyl, cyclobutyl, cyclopentyl, cyclohexyl, cycloheptyl, cyclopentenyl, cyclohexenyl, cyclohexadienyl, cycloheptatrienyl, norbornyl, norpinyl, norcaryl, adamantyl, and spiro[4.5]decanyl groups, as well as their homologs, isomers, and the like. Alkyls can be substituted or unsubstituted. When the term is used with the “substituted” modifier, one or more hydrogen atoms has been independently replaced by any of the substituents disclosed herein.

As used herein, the term “heteroalkyl” refers to an alkyl as defined above having at least one carbon atom replaced by a heteroatom. Examples of cycloheteroalkyl groups include, among others, morpholinyl, thiomorpholinyl, pyranyl, imidazolidinyl, imidazolinyl, oxazolidinyl, pyrazolidinyl, pyrazolinyl, pyrrolidinyl, pyrrolinyl, tetrahydrofuranyl, tetrahydrothiophenyl, piperidinyl, piperazinyl, and the like. Heteroalkyls can be substituted or unsubstituted. When the term is used with the “substituted” modifier, one or more hydrogen atoms has been independently replaced by any of the substituents disclosed herein, or a substituent is bonded to a heteroatom, or both.

As used herein, the term “alkenyl” refers to a straight- or branched-chain hydrocarbon radical or moiety comprising only carbon and hydrogen atoms and having at least one carbon-carbon double bond, which can be internal or terminal. Non-limiting examples of alkenyl groups include: —CH═H₂ (vinyl), —CH═CHCH₃, —CH═CHCH₂CH₃, —CH₂CH═H₂ (allyl), —CH₂CH═CHCH₃, —CH═CH—C₆H₅, —CH(CH₃)CH₂—, and —CH═CHCH₂—. The groups, —CH═CHF, —CH═HCl, —CH═CHBr, and the like. Examples of alkenyl groups include ethenyl, propenyl, butenyl, pentenyl, hexenyl, butadienyl, pentadienyl, hexadienyl groups, and the like. Alkenyls can be substituted or unsubstituted. When the term is used with the “substituted” modifier, one or more hydrogen atoms has been independently replaced by any of the substituents disclosed herein.

As used herein, the term “alkynyl” refers to a straight- or branched-chain hydrocarbon radical or moiety comprising only carbon and hydrogen atoms and having at least one carbon-carbon triple bond, which can be internal or terminal. The groups —C≡CH, —C≡CCH₃, and —CH₂C≡CCH₃, are non-limiting examples of alkynyl groups. Examples of alkynyl groups include ethynyl, propynyl, butynyl, pentynyl, hexynyl, and the like. Alkynes can be substituted or unsubstituted. When the term is used with the “substituted” modifier, one or more hydrogen atoms has been independently replaced by any of the substituents disclosed herein.

As used herein, the term “aryl” refers to a monocyclic or polycyclic aromatic hydrocarbon radical or moiety comprising only carbon and hydrogen atom, wherein the carbon atoms form an aromatic ring structure. If more than one ring is present, the rings may be fused or not fused, or bridged. The term does not preclude the presence of one or more alkyl groups attached to the first aromatic ring or any additional aromatic ring present. The point of attachment can be through an aromatic carbon atom in the ring structure or a carbon atom of an alkyl group attached to the ring structure. Non-limiting examples of aryl groups include phenyl (Ph), toyl, xylyl, methylphenyl, (dimethyl)phenyl, —C₆H₄—CH₂CH₃ (ethylphenyl), naphthyl, and the monovalent group derived from biphenyl. Further examples of aryl groups having only aromatic carbocyclic ring(s) include phenyl, 1-naphthyl (bicyclic), 2-naphthyl (bicyclic), anthracenyl (tricyclic), phenanthrenyl (tricyclic), pentacenyl (pentacyclic), and like groups. Examples of polycyclic ring systems in which at least one aromatic carbocyclic ring is fused to one or more cycloalkyl and/or cycloheteroalkyl rings include, among others, benzo derivatives of cyclopentane (i.e., an indanyl group, which is a 5,6-bicyclic cycloalkyl/aromatic ring system), cyclohexane (i.e., a tetrahydronaphthyl group, which is a 6,6-bicyclic cycloalkyl/aromatic ring system), imidazoline (i.e., a benzimidazolinyl group, which is a 5,6-bicyclic cycloheteroalkyl/aromatic ring system), and pyran (i.e., a chromenyl group, which is a 6,6-bicyclic cycloheteroalkyl/aromatic ring system). When the term is used with the “substituted” modifier, one or more hydrogen atoms has been independently replaced by any of the substituents disclosed herein.

As used herein, the term “heteroaryl” refers to an aryl having at least one aromatic carbon atom in the ring structure replaced by a heteroatom. The term does not preclude the presence of one or more alkyl groups attached to the first aromatic ring or any additional aromatic ring present. The point of attachment can be through an aromatic carbon atom or aromatic heteroatom in the aromatic ring structure or a carbon atom of an alkyl group attached to the aromatic ring structure. Non-limiting examples of heteroaryl groups include furanyl, benzofuranyl, isobenzylfuranyl, imidazolyl, indolyl, isoindolyl, indazolyl, methylpyridyl, oxazolyl, pyridyl, pyrrolyl, pyrimidyl, pyrazinyl, quinolyl, quinazolyl, quinoxalinyl, thienyl, and triazinyl. Additional examples of heteroaryl groups include, for example, the 5- or 6-membered monocyclic and 5-6 bicyclic ring systems such as pyrrolyl, furyl, thienyl, pyridyl, pyrimidyl, pyridazinyl, pyrazinyl, triazolyl, tetrazolyl, pyrazolyl, imidazolyl, isothiazolyl, thiazolyl, thiadiazolyl, isoxazolyl, oxazolyl, oxadiazolyl, indolyl, isoindolyl, benzofuryl, benzothienyl, quinolyl, 2-methylquinolyl, isoquinolyl, quinoxalyl, quinazolyl, benzotriazolyl, benzimidazolyl, benzothiazolyl, benzisothiazolyl, benzisoxazolyl, benzoxadiazolyl, benzoxazolyl, cinnolinyl, 1H-indazolyl, 2H-indazolyl, indolizinyl, isobenzofuyl, naphthyridinyl, phthalazinyl, pteridinyl, purinyl, oxazolopyridinyl, thiazolopyridinyl, imidazopyridinyl, furopyridinyl, thienopyridinyl, pyridopyrimidinyl, pyridopyrazinyl, pyridopyridazinyl, thienothiazolyl, thienoxazolyl, thienoimidazolyl groups, and the like. Further examples of heteroaryl groups include 4,5,6,7-tetrahydroindolyl, tetrahydroquinolinyl, benzothienopyridinyl, benzofuropyridinyl groups, and the like. Heteroaryls can be substituted or unsubstituted. When the term is used with the “substituted” modifier, one or more hydrogen atoms has been independently replaced by any of the substituents disclosed herein, or a substituent is bonded to a heteroatom, or both.

As used herein, the term “aralkyl” refers to an alkyl having at least one hydrogen atom replaced by an aryl or heteroaryl group. Non-limiting examples of aralkyls are: phenylmethyl (benzyl, Bn) and 2-phenyl-ethyl. The point of attachment can be through a carbon atom of the alkyl group or through an aromatic carbon atom or aromatic heteroatom in the aromatic ring structure of the aryl or heteroaryl group attached to the alkyl group. Aralkyls can be substituted or unsubstituted. When the term is used with the “substituted” modifier, one or more hydrogen atoms has been independently replaced by any of the substituents disclosed herein, or a substituent is bonded to a heteroatom, or both.

As used herein, the term “alkaryl” refers to an aryl or heteroaryl having at least one hydrogen atom replaced by an alkyl or heteroalkyl group. The point of attachment can be an aromatic carbon atom or aromatic heteroatom in the aromatic ring structure or a carbon atom of an alkyl group attached to the ring structure. Alkaryls can be substituted or unsubstituted. When the term is used with the “substituted” modifier, one or more hydrogen atoms has been independently replaced by any of the substituents disclosed herein, or a substituent is bonded to a heteroatom, or both.

As used herein, the term “haloaryl” refers to an aryl or heteroaryl having at least one hydrogen atom replaced by a halogen. The point of attachment can be an aromatic carbon atom or aromatic heteroatom in the aromatic ring structure or a carbon atom of an alkyl group attached to the ring structure. Haloaryls can be substituted or unsubstituted. When the term is used with the “substituted” modifier, one or more hydrogen atoms has been independently replaced by any of the substituents disclosed herein, or a substituent is bonded to a heteroatom, or both.

As used herein, the term “alkoxy” refers to the group —OR, wherein R is an alkyl or heteroalkyl group. Non-limiting examples of alkoxy groups include:—OCH₃, —OCH₂CH₃, —OCH₂CH₂CH₃, —OCH(CH₃)₂, —OCH(CH₂)₂, —C₃H₆, —OC₄H₈, —OC₅H₁₀, —OC₆H₁₂, —OCH₂C₃H₆, —OCH₂C₄H₈, —OCH₂C₅H₁₀, —OCH₂C₆H₁₂, and the like. The terms “alkenyloxy”, “alkynyloxy”, “aryloxy”, “aralkoxy”, “heteroaryloxy”, and “acyloxy” refer to the group —OR, wherein R is an alkenyl, alkynyl, aryl, aralkyl, heteroaryl, or acyl group, respectively. Examples include without limitation aryloxy groups such as —O-Ph and aralkoxy groups such as —OCH₂-Ph (—OBn) and —OCH₂CH₂-Ph. Alkoxys, alkenyloxys, alkynyloxys, aryloxys, aralkoxys, heteroaryloxys, and acyloxys can each be substituted or unsubstituted. When those terms are used with the “substituted” modifier, one or more hydrogen atoms has been independently replaced by any of the substituents disclosed herein, or a substituent is bonded to a heteroatom, or both.

As used herein, the term “alkylcarbonyl” refers to a straight-chain or branched alkyl group having up to 12 carbon atoms, which is bound to the remainder of the molecule via a carbonyl group (CO), such as in acetyl, propionyl, isopropylcarbonyl, butylcarbonyl, sec-butylcarbonyl, isobutylcarbonyl, tert-butylcarbonyl, hexylcarbonyl and the constitutional isomers thereof.

As used herein, the term “alkylcarbonyloxy refers to a straight-chain or branched alkyl group having up to 12 carbon atoms, which is bound to the remainder of the molecule via a carbonyloxy group [C(O)—O—], such as in acet(yl)oxy, propionyloxy, isopropylcarbonyloxy, butylcarbonyloxy, sec-butylcarbonyloxy, isobutylcarbonyloxy, tert-butylcarbonyloxy, pentylcarbonyloxy, hexylcarbonyloxy and the constitutional isomers thereof.

As used herein, the term “alkoxycarbonyl” refers to a straight-chain or branched alkoxy group having up to 12 carbon atoms, which is bound to the remainder of the molecule via a carbonyl group (CO), such as in methoxycarbonyl, ethoxycarbonyl, propyloxycarbonyl, and isopropyloxycarbonyl.

As used herein, the term “acyl” refers to the group —C(O)R, wherein R is a hydrogen, alkyl, aryl, aralkyl, or heteroaryl group. Non-limiting examples of acyl groups include: —CHO, —C(O)CH₃ (acetyl, Ac), —C(O)CH₂CH₃, —C(O)CH₂CH₂CH₃, —C(O)CH(CH₃)₂, —C(O)CH(CH₂)₂, —C(O)C₆H₅, —C(O)C₆H₄—CH₃, —C(O)CH₂C₆H₅, and —C(O)(imidazolyl). The groups, —C(O)CH₂CF₃, —CO₂H (carboxyl), —CO₂CH₃ (methylcarboxyl), —CO₂CH₂CH₃, —C(O)NH₂ (carbamoyl), and —CON(CH₃)₂, are non-limiting examples of substituted acyl groups.

As used herein, “amine” and “amino” (and its protonated form) are art-recognized and refer to both unsubstituted and substituted amines, e.g., a moiety that can be represented by the general formula NRR′R″, represented by the structure:

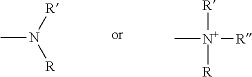

wherein R, R′, and R″ each independently represent a hydrogen, a heteroatom, an alkyl, a heteroalkyl, an alkenyl, —(CH₂)ₘ-Rc or R and R′ taken together with the N atom to which they are attached complete a heterocycle having from 4 to 8 atoms in the ring structure; Rc represents an aryl, a cycloalkyl, a cycloalkenyl, a heterocycle or a polycycle; and m is zero or an integer in the range of 1 to 8, and substituted versions thereof.

The term “alkylamino” when used without the “substituted” modifier refers to the group —NHR, in which R is an alkyl, as that term is defined above. Non-limiting examples of alkylamino groups include: —NHCH₃ and —NHCH₂CH₃. The terms “alkoxyamino”, “alkenylamino”, “alkynylamino”, “arylamino”, “aralkylamino”, “heteroarylamino”, and “alkylsulfonylamino” when used without the “substituted” modifier, refers to groups, defined as —NHR, in which R is alkoxy, alkenyl, alkynyl, aryl, aralkyl, heteroaryl, and alkylsulfonyl, respectively. A non-limiting example of an arylamino group is —NHC₆H₅. The term “amido” (acylamino), when used without the “substituted” modifier, refers to the group —NHR, in which R is acyl, as that term is defined above. A non-limiting example of an amido group is —NHC(O)CH₃. The term “alkylimino” when used without the “substituted” modifier refers to the divalent group ═NR, in which R is an alkyl, as that term is defined above.

As used herein, the terms “halide,” “halo,” and “halogen” refer to —F, —Cl, —Br, or —I.

As used herein, the term “substituent” and “substituted” refers to all permissible substituents of the compounds described herein. In the broadest sense, the permissible substituents include acyclic and cyclic, branched and unbranched, carbocyclic and heterocyclic, aromatic and nonaromatic substituents of organic compounds. Examples of substituents include, without limitation, nothing, alkyl, substituted alkyl, cycloalkyl, substituted cycloalkyl, heteroalkyl, substituted heteroalkyl, alkenyl, substituted alkenyl, alkynyl, substituted alkynyl, aryl, substituted aryl, heteroaryl, substituted heteroaryl, aralkyl, substituted aralkyl, alkaryl, substituted alkaryl, haloaryl, substituted haloaryl, alkoxy, substituted alkoxy, alkenyloxy, substituted alkenyloxy, alkynyloxy, substituted alkynyloxy, aryloxy, substituted aryloxy, aralkoxy, substituted aralkoxy, heteroaryloxy, substituted heteroaryloxy, acyloxy, substituted acyloxy, acyl, substituted acyl, halo (—F, —Cl, —Br, —I, etc.), hydrogen (—H), carboxyl (—COOH), hydroxy (—OH), oxo (═O), hydroxyamino (—NHOH), nitro (—NO₂), cyano (—CN), isocyanate azido (—N₃), phosphate (e.g., —OP(O)(OH)₂, —OP(O)(OH)O—, deprotonated forms thereof, etc.), mercapto (—SH), thio (═S), thioether (═S—), sulfonamido (—NHS(O)₂—), sulfonyl (—S(O)₂—), sulfinyl (—S(O)₂—), any combinations thereof, and the like.

Additional examples of substituents include, but are not limited to, —NC, —S(R⁰)₂⁺—N(R⁰)₃⁺—SO₃H, —SO₂R⁰, —SO₃R⁰, —SO₂NHR⁰, —SO₂N(R⁰)₂, —COR⁰, —COOR⁰, —CONHR⁰, CON(R⁰)₂, C₁₋₄₀ haloalkyl groups, C₆₋₁₄ aryl groups, and 5-14 membered electron-poor heteroaryl groups; where R⁰ is a C₁₋₂₀ alkyl group, a C₂₋₂₀ alkenyl group, a C₂₋₂₀ alkynyl group, a C₁₋₂₀ haloalkyl group, a C₁₋₂₀ alkoxy group, a C₆₋₁₄ aryl group, a C₃₋₁₄ cycloalkyl group, a 3-14 membered cycloheteroalkyl group, and a 5-14 membered heteroaryl group, each of which can be optionally substituted as described herein. Additional examples of substituents include, but are not limited to, —OR⁰, —NH₂, —NHR⁰, —N(R⁰)₂, and 5-14 membered electron-rich heteroaryl groups, where R⁰ is a C₁₋₂₀ alkyl group, a C₂₋₂₀ alkenyl group, a C₂₋₂₀ alkynyl group, a C₆₋₁₄ aryl group, or a C₃₋₁₄ cycloalkyl group.

### DISCUSSION

While there have been attempts to fabricate, for example, covalent organic frameworks and metal-organic frameworks as thin films on various substrates and use them as separators, the methods that were utilized resulted in the formation of films with cracks and defects. In addition, the films had the negative characteristic of being fragile and difficult to handle, making scale-up particularly challenging. The rigidity and lack of flexibility of the resulting films contributed to these and other issues. Further, the reported fabrication methods suffered from complicated processes that made it hard to control the thickness of the electrode separator (and thus to scale-up) and required extensive investments of time. Another reported fabrication method failed to obtain a sufficiently thin film and the resulting membrane was very fragile, limiting its application.

The present invention provides electrode separators and methods of fabricating electrode separators that overcome the foregoing and other challenges known in the art. Embodiments provide, for example, electrode separators comprising a flexible freestanding membrane or thin film including a microporous material and a threading polymer associated with the flexible freestanding membrane (or thin film) via one or more non-covalent interactions and/or via crosslinking. In such embodiments, a low amount of a threading polymer can be introduced into the microporous material to obtain freestanding membranes that are not only defect- and/or crack-free, but also have improved flexibility and mechanical stability. The threading polymer, acting as a sort of binder material (without being one at low amounts), can associate with the microporous material through one or more non-covalent interactions and/or via crosslinking. These associations can hold the microporous material together and impart a degree of flexibility to the membranes, thereby improving handling and processing post-synthesis. For example, at least one advantage of the membranes' improved flexibility is that they can now be processed or punched into specific shapes and sizes to meet the particular specifications for a wide array of batteries and electrochemical cells.

In addition, the methods are simple and scalable and can be performed in a simple one-pot in-situ synthesis in which precursors for the microporous membrane and threading polymer are mixed, heated, deposited on a support, allowed to react and/or dry, and immersed in another solvent to delaminate the microporous membrane from the support and obtain the electrode separator. The method provides great flexibility in terms of size, thickness, and quality of the resulting film, as well as improved properties such as flexibility and improved handling. For example, the resulting films can now be processed and punched into various shapes and/or sizes. The polymers can be selected or adapted according to the microporous material being employed (or vice versa). A wide range of polymers can be utilized herein. Examples of selection factors include whether the polymer is flexible, how the polymer interacts with the microporous material, etc. Although permitted in principle, it is preferred to not use glass polymers.

Electrode separators based on these materials exhibit the requisite chemical and electrochemical stability in electrolyte and electrode materials, and the mechanical stability required to endure the stresses involved in battery manufacturing. The electrode separators disclosed herein advantageously exhibit uniform pore size and very low conductivity. In addition, the electrode separators can be fabricated according to simple and scalable one-pot processes that permit the possibility to use different types of porous materials to afford different chemical functionality and pore sizes, thereby enhancing the functionality of such membranes as electrode separators. For example, different hybrid porous materials/polymer systems can be fabricated with different properties for use as a separator in different types of batteries. In this way, the electrode separators disclosed herein have great potential for the enhancement and commercialization of next-generation batteries, which include without limitation lithium ion batteries, lithium-sulfur batteries, sodium ion batteries, zinc ion batteries, and the like.

Embodiments of the present disclosure provide an electrode separator. The electrode separator can include a freestanding microporous membrane or a freestanding microporous thin film (hereinafter collectively referred to as a freestanding microporous membrane), and a threading polymer associated with the freestanding membrane via one or more non-covalent interactions and/or via crosslinking, wherein each of the threading polymer and freestanding microporous membrane include at least one moiety that participates in the one or more non-covalent interactions and/or crosslinking.

The freestanding microporous membrane can include a microporous material, such as a crystalline microporous material. In some embodiments, the freestanding microporous material includes one or more covalent organic frameworks (COFs). In some embodiments, the freestanding microporous material includes one or more metal-organic frameworks (MOFs). In some embodiments, the freestanding microporous material includes one or more polymers of intrinsic microporosity (PIMs). In some embodiments, the freestanding microporous material includes one or more Porous Organic Polymers (POPs). In some embodiments, the freestanding microporous material includes one or more Porous Aromatic Frameworks (PAFs). In some embodiments, the freestanding microporous material includes a Porous Polymer Networks (PPNs). In some embodiments, the freestanding microporous material includes one or more Conjugated Microporous Polymers (CMPs). In some embodiments, the freestanding microporous material includes one or more Microporous Polymer Networks (MPNs). In some embodiments, the freestanding microporous material includes one or more Hyper Crossed-linked Polymers (HCPs), In some embodiments, the freestanding microporous material includes one or more Coordination Polymers (CPs). In some embodiments, freestanding microporous material includes one or more Porous Coordination Polymers (PCPs). In some embodiments, the freestanding microporous material includes one or more Porous Coordination Networks (PCNs). In some embodiments, the freestanding microporous material includes one or more Metal-Organic Materials (MOMs). In some embodiments, the freestanding microporous material includes one or more of COFs, MOFs, PIMs, POPs, PAFs, PPNs, CMPs, MPNs, HCPs, CPs, PCPs, PCNs, and MOMs.

The threading polymer can include a polymeric material which can be provided in the form of a monomer, oligomer, and/or polymer, each of which can independently be substituted or unsubstituted, functionalized or not functionalized, and optionally water soluble. In some embodiments, the threading polymer includes a homopolymer. In some embodiments, threading polymer includes a copolymer. For example, in some embodiments, the threading polymer includes a linear polymer. In some embodiments, the threading polymer includes a branched copolymer. In some embodiments, the threading polymer includes a graft copolymer. In some embodiments, the threading polymer includes a block copolymer. In some embodiments, the threading polymer includes an alternating copolymer. In some embodiments, the threading polymer includes a periodic copolymer. In some embodiments, the threading polymer includes a statistical copolymer. In some embodiments, the threading polymer includes a stereoblock copolymer. In some embodiments, the threading polymer includes a gradient copolymer. In some embodiments, the threading polymer includes a star copolymer.

The freestanding microporous membrane and threading polymer can each include, be selected to include, be synthesized or purchased to include, and/or be modified (e.g., post-synthesis) to include or further include at least one moiety that participates in a non-covalent interaction and/or crosslinking. Moieties having the capability to participate in a non-covalent interaction and/or crosslinking but which do not so participate are permitted, provided that each of the threading polymer and freestanding microporous membrane include at least one moiety that participates in the non-covalent interaction and/or crosslinking. The moiety can be attached to or be a part of any part of the freestanding microporous membrane and/or microporous material. Similarly, the moiety can be attached to or be a part of any part of the threading polymer. In some embodiments, the at least one moiety is incorporated into or present along the polymer backbone of the threading polymer. In some embodiments, the at least one moiety is attached to the polymer backbone of the threading polymer. In some embodiments, the at least one moiety is attached to a pendant chain of the threading polymer. In some embodiments, the at least one moiety is attached to a pendant group of the threading polymer.

Each moiety attached to the freestanding microporous membrane and threading polymer can independently participate in a single non-covalent interaction or a plurality of non-covalent interactions. In some embodiments, the freestanding microporous membrane includes one or more moieties that participate in only one non-covalent interaction, in a plurality of non-covalent interactions, or combinations thereof.

In some embodiments, the threading polymer includes one or more moieties that participate in only one non-covalent interaction, in a plurality of non-covalent interactions, or combinations thereof. In one embodiment, a moiety attached to the threading polymer can participate in hydrogen bonding with each of two moieties attached to the freestanding microporous membrane, wherein each of the two moieties attached to the freestanding microporous membrane only participate in a single non-covalent interaction—i.e., hydrogen bonding with the moiety attached to the threading polymer. This example can extend to other types of non-covalent interactions and other arrangements thereof, without regard to whether the moiety is attached to the freestanding microporous membrane or the threading polymer.

The non-covalent interactions between the freestanding microporous membrane and threading polymer generally include interactions which do not involve the formation of a covalent bond. For example, in some embodiments, the one or more non-covalent interactions include hydrogen bonding. In some embodiments, the one or more non-covalent interactions include electrostatic dipole-dipole interactions. In some embodiments, the one or more non-covalent interactions include hydrogen bonding and electrostatic dipole-dipole interactions. In some embodiments, the one or more non-covalent interactions include at least one of the following: hydrogen bonding and electrostatic dipole-dipole interactions.

The interactions between the freestanding microporous membrane and the threading polymer can also exclude certain interactions. For example, in some embodiments, no covalent bond is formed or exists between the freestanding microporous membrane and the threading polymer. In some embodiments, the interactions between the freestanding microporous membrane and the threading polymer exclude interactions other than hydrogen bonding. In some embodiments, the interactions between the freestanding microporous membrane and the threading polymer consist of hydrogen bonding. In some embodiments, the interactions between the freestanding microporous membrane and the threading polymer exclude interactions other than hydrogen bonding and electrostatic dipole-dipole interactions. In some embodiments, the interactions between the freestanding microporous membrane and the threading polymer consist of hydrogen bonding and electrostatic dipole-dipole interactions. In some embodiments, the interactions between the freestanding microporous membrane and the threading polymer exclude interactions other than electrostatic dipole-dipole interactions. In some embodiments, the interactions between the freestanding microporous membrane and the threading polymer consist of electrostatic dipole-dipole interactions. In some embodiments, the interactions between the freestanding microporous membrane and the threading polymer exclude at least one of the following non-covalent interactions: ionic interactions, van der Waal's interactions, and electrostatic dipole-dipole interactions.

Hydrogen bonding can involve non-covalent interactions between at least one hydrogen bond donor moiety and at least one hydrogen bond acceptor moiety. Electrostatic dipole-dipole interactions can involve non-covalent interactions between at least one first polar moiety and at least one second polar moiety, which can be the same or different. In some embodiments, the freestanding microporous membrane includes one or more hydrogen bond donor moieties. In some embodiments, the freestanding microporous membrane includes one or more hydrogen bond acceptor moieties. In some embodiments, the freestanding microporous membrane includes one or more polar moieties. In some embodiments, the freestanding microporous membrane includes at least one of the following: one or more hydrogen bond donor moieties, one or more hydrogen bond acceptor moieties, and one or more polar moieties. In some embodiments, the threading polymer includes one or more hydrogen bond donor moieties. In some embodiments, the threading polymer includes one or more hydrogen bond acceptor moieties. In some embodiments, the threading polymer includes one or more polar moieties. In some embodiments, the threading polymer includes at least one of the following: one or more hydrogen bond donor moieties, one or more hydrogen bond acceptor moieties, and one or more polar moieties.

In some embodiments, the freestanding microporous membrane includes at least one hydrogen bond donor moiety and the threading polymer includes at least one hydrogen bond acceptor moiety, wherein the at least one hydrogen bond donor moiety and at least one hydrogen bond acceptor moiety form hydrogen bonding. In some embodiments, the freestanding microporous membrane includes at least one hydrogen bond acceptor moiety and the threading polymer includes at least one donor moiety, wherein the at least one hydrogen bond donor moiety and at least one hydrogen bond acceptor moiety form hydrogen bonding. In some embodiments, the freestanding microporous membrane includes at least one first polar moiety and the threading polymer includes at least one second polar moiety, wherein the at least one first polar moiety and at least one second polar moiety form electrostatic dipole-dipole interaction. In some embodiments, the first polar moiety and the second polar moiety are the same. In some embodiments, the first polar moiety and the second polar moiety are different.

Examples of hydrogen bond donor moieties include, without limitation, —O—H, —N—H, —P—H, —S—H, ≡C—H, —C(═O)—H, and —C(E₁E₂)-H, where E₁ and E₂ are each independently selected from O, F, Cl, and Br. Examples of suitable hydrogen bond acceptor moieties include, without limitation, —C═O, —N—H, —N(H)—, —O—H, —C—F, —C(F)—, —P═O, —P(═O)—, —C≡N—, —C—O—, —C═N—, —C—NO₂, and —C—SO₃H. Examples of suitable polar moieties include, but are not limited to, hydroxyls, carboxyls, carbonyls, esters, ethers, amines, thiols, halogens, sulfones, phosphates, sulfonamides, carbonates, and the like. Any one or more of the foregoing hydrogen bond donor moieties, hydrogen bond acceptor moieties, and polar moieties can be independently attached to or a part of the freestanding microporous membrane and threading polymer, in any combination.

In some embodiments, the freestanding microporous membrane includes at least one of the following hydrogen bond donor moieties: —O—H, —N—H, —P—H, —S—H, ≡C—H, —C(═O)—H, and —C(E₁E₂)-H, where E₁ and E₂ are each independently selected from O, F, Cl, and Br. In some embodiments, the freestanding microporous membrane includes at least one of the following hydrogen bond acceptor moieties: —C═O, —N—H, —N(H)—, —O—H, —C—F, —C(F)—, —P═O, —P(═O)—, —C≡N, —C—O—, —C═N—, —C—NO₂, and —C—SO₃H. In some embodiments, the freestanding microporous membrane includes at least one of the following polar moieties: hydroxyl, carboxyl, carbonyl, ester, ether, amine, thiol, halogen, sulfone, phosphate, sulfonamide, and carbonate. In some embodiments, the freestanding microporous membrane includes one or more of the following: one or more of the foregoing hydrogen bond donor moieties, one or more of the foregoing hydrogen bond acceptor moieties, and one or more of the foregoing polar moieties.

In some embodiments, the threading polymer includes at least one of the following hydrogen bond donor moieties: —O—H, —N—H, —P—H, —S—H, ≡C—H, —C(═O)—H, and —C(E₁E₂)-H, where E₁ and E₂ are each independently selected from O, F, Cl, and Br. In some embodiments, the threading polymer includes at least one of the following hydrogen bond acceptor moieties: —C═O, —N—H, —N(H)—, —O—H, —C—F, —C(F)—, —P═O, —P(═O)—, —C≡N, —C—O—, —C═N—, —C—NO₂, and —C—SO₃H. In some embodiments, the threading polymer includes at least one of the following polar moieties: hydroxyl, carboxyl, carbonyl, ester, ether, amine, thiol, halogen, sulfone, phosphate, sulfonamide, and carbonate. In some embodiments, the threading polymer includes one or more of the following: one or more of the foregoing hydrogen bond donor moieties, one or more of the foregoing hydrogen bond acceptor moieties, and one or more of the foregoing polar moieties.

In some embodiments, the threading polymer is selected from polymers including one or more hydrogen bond donor moieties. For example, in some embodiments, the threading polymer is selected from the following: polystyrene sulfonate, polycarboxylic acids such as polyacrylic acids and polymethacrylic acids, polyvinyl alcohols, polyacrylamides, polyethylene glycols, polyamines, polyethyleneimines, quaternary ammonium polymers, polyvinylpyrrolidone, copolymers thereof, block copolymers thereof, or combinations thereof. In some embodiments, the threading polymer is selected from polymers including one or more hydrogen bond acceptor moieties. For example, in some embodiments, the threading polymer is selected from the following: polyethers such as polyethylene oxide, poly(1,2-dimethoxyethylene), poly(vinylmethyl ether), and poly(vinylbenzo-18-crown-6); polyketones and polyaldehydes, such as polyvinyl butyral and poly(N-vinyl-2-pyrrolidone); polyacrylamides, such as polyacrylamide, polymethacrylamide, and poly(N-isopropylacrylamide); polyamines, such as poly(-amine)styrene; polyesters such poly(cylohexane-1,4-dimethylene terephthalate) and polyhydroxy methyl acrylate; polyphosphazenes, such as poly(bis(methylamino)phosphazene) and poly(bis(methoxyethoxyethoxy)phosphazene; and polysaccharides such as carboxymethyl cellulose; copolymers thereof, block copolymers thereof; or combinations thereof. In some embodiments, it is selected from polymers including polar moieties. For example, in some embodiments, the threading polymer is selected from the following: polyester, polyamide, polyether, polyetherimide, polyvinyl alcohol, polycarbonate, polyurethane, polylactic acid, polyamide ester, and polyvinyl chloride.

The threading polymer content can, in some instances, affect the flexibility and performance of the freestanding membrane or thin film as an electrode separator. For example, an increase in threading polymer content can increase the flexibility of the freestanding membrane or thin film, but also, in some instances, decrease its performance as an electrode separator. Accordingly, the threading polymer content can be varied to achieve the desired flexibility and/or performance suitable for a given application. In certain embodiments, the threading polymer content of the electrode separator is less than about 50% by weight, less than about 45% by weight, less than about 40% by weight, less than about 35% by weight, less than about 30% by weight, less than about 25% by weight, less than about 20% by weight, less than about 15% by weight, less than about 10% by weight, less than about 5% by weight, less than about 1% by weight, or any incremental range or value thereof. Preferably, the threading polymer content is less than about 25% by weight, or more preferably less than about 20% by weight. All percentages by weight are based on the total weight of the electrode separator.

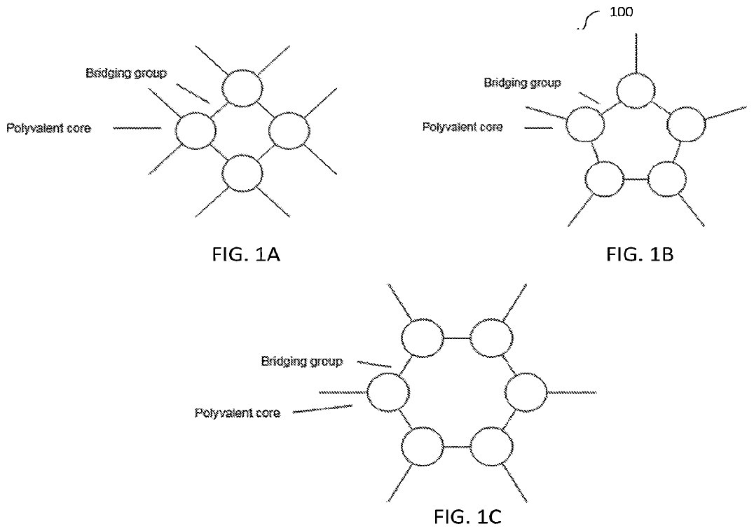

In some embodiments, the microporous materials can be assembled or constructed from a framework of molecular structures, such as those depicted in FIGS. 1A-1C. As shown in FIGS. 1A-1C, the polyvalent core can bond with two or more bridging groups to form a scaffold which can be combined with other scaffolds to form one-, two-, and/or three-dimensional structures. These structures can comprise a polyvalent core, which include one or more metals or metal ions, or moieties, capable of bonding with two or more bridging groups to form a scaffold. The polyvalent core can also exclude metals and/or metal ions. For example, the polyvalent core can be metal free. The bonds between the polyvalent core and bridging groups are not particularly limited and can include covalent bonds, ionic bonds, coordination bonds, dative bonds, and the like. The scaffolds or regions thereof can be one-, two-, or three-dimensional in structure and can be selected from one of the various bonding motifs shown in FIGS. 1A-1C. Depending on the core and bridging group, the scaffolds can include, be selected to include, be synthesized or purchased to include, and/or be modified (e.g., post-synthesis) to include or further include at least one moiety that participates in a non-covalent interaction.

The polyvalent cores can comprise a single metal ion or non-metal ion, or a cluster of metal ions and/or non-metal ions, and/or one or more moieties, all or any one of which are capable of bonding with two or more bridging groups. For example, in certain embodiments, the polyvalent core can comprise carbon, silicon, multi-valent organic moieties (e.g., a di-, tri-, or quadravalent organic moiety, such as a carbon atom, ethylene group, aryl group, and the like), or metal ions. In some embodiments, the polyvalent core includes light elements. Non-limiting examples of suitable light elements include B, C, N, O, P, and the like. In some embodiments, the polyvalent core includes metals, such as alkali metals, alkaline earth metals, transition metals, post-transition metals, lanthanoids, and actinoids. Non-limiting examples of suitable metal ions include ions of Li, Na, K, Cs, Mg, Ca, Sr, Ba, Sc, Y, Ti, Zr, Hf, V, Nb, Ta, Cr, Mo, W, Mn, Re, Fe, Ru, Os, Co, Rh, Ir, Ni, Pd, Pt, Cu, Ag, Au, Zn, Cd, Hg, Al, Ga, In, Ti, Si, Ge, Sn, Pb, As, Sb, and Bi.

The bridging group can be a polydentate group, for example, a C2-C12 hydrocarbon chain optionally containing at least one double bond, at least one triple bond, or at least one double bond and one triple bond and optionally comprising at least one of —O—, —N(Rc)-, or S in the hydrocarbon backbone or chain, or a C3-C16 cyclic group, which is optionally aromatic (e.g., an aryl) and optionally comprises one or more heteroatoms. Rc can be H or C1-4 alkyl. The bridging group can be further optionally substituted with alkyl, alkenyl, alkynyl, alkoxy, hydroxyl, hydroxylalkyl, halo, haloalkyl, amino, carboxyl, amido, C1-4 alkyl, C2-4 alkenyl, C2-4 alkynyl, C1-4 alkoxy, nitro, cyano, C3-5 cycloalkyl, 3-5 membered cycloheteroalkyl, monocyclic aryl, 5-6 membered heteroaryl, C1-4 alkylcarbonyloxy, C1-4 alkoxycarbonyl, C1-4 alkylcarbonyl, and/or formyl group, which is capable of bonding to 2, 3, 4, 5, or 6 or more of the polyvalent cores.

In some embodiments, the microporous material comprises a covalent organic framework (COF). The COF can comprise at least one core covalently bonded to one or more linking moieties. The core or linking moiety or both can comprise light elements, such as boron, carbon, nitrogen, oxygen, phosphorus, and hydrogen. As provided above, the COFs can include, be selected to include, be synthesized or purchased to include, and/or be modified (e.g., post-synthesis) to include or further include at least one moiety that participates in a non-covalent interaction. For example, in some embodiments, the COF includes or is modified to include or further include one or more hydrogen bond donor moieties, one or more hydrogen bond acceptor moieties, and/or one or more polar moieties.

Examples of suitable COFs include without limitation boron-containing COFs, triazine-based COFs, imine-based COFs, and the like. Examples of boron-containing COFs include, without limitation, COF-1, COF-102, COF-13, PPy-COF, COF-102-C₁₂, COF-102-allyl, COF-5, COF-105, COF-108, COF-6, COF-8, COF-10, COF-11 Å, COF-14 Å, COF-16 Å, COF-18 Å, TP-COF, Pc-PBBA COF, NiPc-PBBA COF, 2D-NiPc-BTDA COF, NiPc COF, BTP-COF, HHTP-DPB COF, 2D D-A COF, x % N₃—COF-5 where x is 5, 25, 50, 75, or 100, 100% N₃-NiPc-COF, N₃-BDBA COF, x % RTrzCOF-5 where R is Ac, Bu, Ph, Es, or Py and X is 5, 25, 50, 75, or 100, 100% RTrz-NiPc-COF where R is Ac, Bu, Ph, Es, or Py, COF-66, ZnPc-Py COF, ZnPc-DPB COF, ZnPc-NDI COF, ZnPc-PPE COF, CTC-COF, H₂P—COF, ZnP—COF, CuP—COF, COF-202, and the like. Examples of triazine-based COFs include, without limitation, CTF-1, CTF-2, and the like. Examples of imine-based COFs include, without limitation, COF-300, COF-LZU1, COF-366, COF-42, COF-43, and the like.

In some embodiments, the microporous material comprises a MOF. The MOFs can comprise a ligand component coordinated to a metal component. As provided above, the MOFs can include, be selected to include, be synthesized or purchased to include, and/or be modified (e.g., post-synthesis) to include or further include at least one moiety that participates in a non-covalent interaction. For example, in some embodiments, the MOF includes or is modified to include or further include one or more hydrogen bond donor moieties, one or more hydrogen bond acceptor moieties, and/or one or more polar moieties.

The metal component can include a single metal or metal ion or a plurality of metals or metal ions, such as metal clusters or mixtures of metals. In some embodiments, the metal is selected from Mg, Ca, Sr, Ba, Sc, Y, Ti, Zr, Hf, V, Nb, Ta, Cr, Mo, W, Mn, Re, Fe, Ru, Os, Co, Rh, Ir, Ni, Pd, Pt, Cu, Ag, Au, Zn, Cd, Hg, Al, Ga, In, Ti, Si, Ge, Sn, Pb, As, Sb, and Bi. In some embodiments, the metal is selected from Ce, Dy, Er, Eu, Gd, Ho, La, Lu, Nd, Pr, Pm, Sm, Sc, Tb, Tm, Yb, Y, any cations thereof, and any combinations thereof. In some embodiments, the metal is selected from Na, K, Li, Ag, Cu, Zn, Co, Ni, Mn, Mo, Cr, Fe, Ca, Ga, Ba, Cs, Pb, Pt, Pd, Ru, Rh, Cd, Mg, Al, In, Sc, Nb, Y, Ln, Yb, Tb, Zr, Ti, V, any cations thereof, and any combinations thereof. In some embodiments, the metal is selected from Cu²⁺, Zn²⁺, Co²⁺, Ni²⁺, Mn²⁺, Zr²⁺, Fe²⁺, Ca²⁺, Ba²⁺, Pb²⁺, Pt²⁺, Pd²⁺, Ru²⁺, Rh²⁺, Cd²⁺, Mg⁺², Al⁺³, Fe⁺², Fe⁺³, Cr²⁺, Cr³⁺, Ru²⁺, Ru³⁺, Co³, Ti³⁺, V³⁺, V⁵⁺, Sc³⁺, In³⁺, Nb⁵⁺, Y³⁺, and any combinations thereof. In some embodiments, the metal is selected from Al⁺³, Ga³⁺, Fe⁺², Fe⁺³, Cr²⁺, Cr³⁺, Ti³⁺, V³⁺, V⁵⁺, Sc³⁺, In³⁺, Nb⁵⁺, Y³⁺, and any combinations thereof.

The ligand component can include any organic linker compounds conventionally used in MOF production. The ligand may comprise various complexing functions comprising carboxylates, phosphonates, imidazolates, preferably from 2 to 6 functional groups being mono, bi, tri or tetradentates, i.e. possibly comprising 1, 2, 3 or 4 points of attachment to the metal-based node. Non-limiting examples of suitable ligands include oxalic acid, ethyloxalic acid, fumaric acid, 1,3,5-benzene tricarboxylic acid (BCT), acetylene dicarboxylate (ADC), naphtalene dicarboxylate (NDC), benzene tricarboxylate (BTC), methane tetrabenzoate (MTB), adamantane tribenzoate (ATB), 1,3,5-benzene tribenzoic acid (BTB), benzene tribiphenylcarboxylic acid (BBC), 5,15-bis (4-carboxyphenyl) zinc (II) porphyrin (BCPP), 1,4-benzene dicarboxylic acid (BDC), 2-amino-1,4-benzene dicarboxylic acid (R₃-BDC or H₂N BDC), 1,1′-azo-diphenyl 4,4′-dicarboxylic acid, cyclobutyl-1,4-benzene dicarboxylic acid (R₆-BDC), benzene tricarboxylic acid, 2,6-naphthalene dicarboxylic acid (NDC), 1,1′-biphenyl 4,4′-dicarboxylic acid (BPDC), 2,2′-bipyridyl-5,5′-dicarboxylic acid, adamantane tetracaboxylic acid (ATC), adamantane dibenzoic acid (ADB), adamantane teracarboxylic acid (ATC), dihydroxyterephthalic acid (DHBDC), biphenyltetracarboxylic acid (BPTC), tetrahydropyrene 2,7-dicarboxylic acid (HPDC), hihydroxyterephthalic acid (DHBC), pyrene 2,7-dicarboxylic acid (PDC), pyrazine dicarboxylic acid, acetylene dicarboxylic acid (ADC), camphor dicarboxylic acid, fumaric acid, benzene tetracarboxylic acid, 1,4-bis(4-carboxyphenyl)butadiyne, nicotinic acid, and terphenyl dicarboxylic acid (TPDC). Other acids besides carboxylic acids, e.g. boronic acids may be used. In some cases, the nodes, ligands and solvents are selected based on a target topology or to tune the pore size of a target MOF.

Examples of suitable MOFs include, but are not limited to, MOF-5, MOF-177, MOF-74/CPO-27, MOF-210, MOF-505, MOF-200, MOF-253, MOF-508, IMOF-3, MOF-4, MOF-602, MOF-603, MOF-2, sod-ZMOF, rho-ZMOF, MOF-205, IRMOF-1, IRMOF-2, IRMOF-3, Zn-MOF-1, Zn-MOF-2, Zn-MOF-3, Zn-MOF-4, Zn-MOF-5, Cu-MOF-1, Cu-MOF-2, Tb-MOF-1, Tb-MOF-2, Cd-MOF-1, Cd-MOF-2, Cd-MOF-3, Co-MOF-1, Co-MOF-2, Zn-MOF-6, MOF-5, Cu(4,4′-bpy)_{1.5}NO₃(H₂O)_{1.25}, [Cu₃(TMA)₂]ₙ, [Cu(OH)—(C₅H₄NCO₂]ₙ, MOF-38, Ag(4,4′-bpy)NO₃, IRMOF-7, CPL-11, CPL-2, BIF-2Li, BIF-2Cu, BIF-9, BIF-4, BIF-10, BIF-6, BIF-7, BIF-8, BIF-3, BIF-5, TIF-1, TIF-2, TIF-5, TIF-3, TIF-4, PCN-6, PCN-14, PCN-66, PCN-12, PCN-224, PCN-9, PCN-13, PCN-17, PCN-333, PCN-225, PCN-332, PCN-250, PCN-222, PCN-61, PCN-521, PCN-46, PCN-223, UMCM02, UMCM-150, UMCM-1, MIL-53, MIL-53 (A1), MIL-100, MIL-101, MIL-96, MIL-47, MIL-102, MIL-117, MIL-142A, MIL-141, MIL-140, MIL-88, MIL-120, MIL-84, MIL-91, SNU-25, SNU-50′, SNU-15, SNU-M10, SNU-M11, SNU-21S, SNU-21H, SNU-30, SNU-3, SNU-9, SNU-21, SNU-31′, DUT-10, DUT-4, DUT-51, DUT-13, UR-6, NOTT-100, NOTT-140, NOTT-140a, NOTT-107, NOTT-109, NOTT-300, NOTT-116, UMCM-150, USO-2-Ni, USO-3-In, USO-1-Al-A, MSF-2, Cu-BTTri, ELM-11, Ni-STA-12, IRMOF-11, IRMOF-6, IRMOF-62, IRMOF-3, MOP-23, Mn(pmdc), Co(timb), YO-MOF, Cd-ADA-1, CdlF-9, Cu-EBTC, Zn₂(BTetB), Cu₂(bptb), ELM-31, NU-100, NU-135, NU-125, NU-140, NU-111, NU-700, Zn(3,5-pydc)(DMA), H₃(Cu₄Cl)₃(BTTri)₈, Cu₂(imta)(DMSO), Co(dcdd), Co₄((OH)₂(dcdd)₃, Cd₂(tzc)₂, Mn(HCO₂)₂, Cu₂I₂(bttp₄), Cu(1,4-ndc), Zn(bchp), Ni2(pbmp), Zn(3,5-pydc)(DMA), Zn4O(bmpbdc)3, Zn₂(bdc)₂(dabco), UTSA-16, UTSA-20, UTSA-34, UTSA-40, UTSA-38, UTSA-100, UTSA-100a, ZJU-5, ZJU-25, ZJU-35, Cu-TaTB-30, CAU-1, CAU-10-H, UoC-1, Co-BDP, MFU-4, Zn₄O(bfbpdc)₃, HNUST-2, NHUST-3, UiO-66-NH₂, UiO-66-CH₃, UiO-67, Cu(fma), Cu₂(sdc)₂(ted), Cu₃(tatb), Cu₃(btb), Zn₄O(ma)₃, MTAF-4, CU₃(btc)₂, ZN₄O(dmcapz)₃, FMOF-1, FMOF-2, Co(dcdd)(ph)₂, ZJNU-42, MPF-2, MPF-9, VSB-3, bio-MOF-1, bio-MOF-11, HLJU-1, HLJU-2, NENU-3, NENU-28, NENU-29, NENU-15, NENU-11, TMOF-1, Cu-BTT, Ni-BTT, SIFSIX-2-Cu, SIFSIX-2-Cu—I, SIFSIX-3-Zn, SIFSIX-3-Cu, ELM-11, DO-MOF, oCB-MOF-1, PCMOF-5, CDMOF-2, HKUST-1, Al(fumarate)(OH), Zr(fumarate), isoreticular and/or isostructural MOFs thereof with different metal ions and/or ligands, and the like. In certain embodiments, the MOF is a zeolitic-imidazole framework (ZIF). Examples of suitable ZIFs include, but are not limited to, ZIF-1, ZIF-2, ZIF-3, ZIF-4, ZIF-5, ZIF-6, ZIF-7, ZIF-8, ZIF-9, ZIF-10, ZIF-11, ZIF-12, ZIF-14, ZIF-20, ZIF-21, ZIF-22, ZIF-23, ZIF-25, ZIF-60, ZIF-61, ZIF-62, ZIF-63, ZIF-64, ZIF-65, ZIF-66, ZIF-67, ZIF-68, ZIF-69, ZIF-70, ZIF-71, ZIF-72, ZIF-73, ZIF-74, ZIF-75, ZIF-76, ZIF-78, ZIF-81, ZIF-82, ZIF-90, ZIF-91, ZIF-92, ZIF-93, ZIF-96, ZIF-97, ZIF-100, and the like.

In addition or in the alternative, the electrode separators can include a microporous material, wherein the microporous material is modified post-synthesis to include a functional group that crosslinks the microporous material and wherein the crosslinking of the microporous material produces a freestanding microporous membrane or a freestanding microporous thin film. The electrode separators can include any of the microporous materials disclosed herein and the microporous materials can be modified to include any functional group capable of crosslinking the microporous material. For example, in some embodiments, the microporous material includes a polymer of intrinsic microporosity (PIM), examples of which include reaction products of the PIM materials disclosed herein. In some embodiments, the functional groups include at least one of the following moieties: —NH₂, —OH, —COOH, —SO₃H, and —PO₃H₂. In other embodiments, a polymer, such as the threading polymers disclosed herein, is used in place of the microporous material or in combination with the microporous material, and the polymer produces the freestanding microporous membrane or freestanding microporous thin film.

Examples of PIMs that can be utilized herein include, without limitation, the following: PIM-1, PIM-2, PIM-3, PIM-4, PIM-5, PIM-6, PIM-7, PIM-8, PIM-9, PIM-10, Cardo-PIM-2, PIM-CO-100, MP-1, PIM-0015, PIM-HPB, PIM-SBF, TOT-PIM-100, TOT-PIM-50, DNTOT-PIM-50, DN-PIM-50, DSPIM1-100, DSPIM2-100, DSPIM3-100, PSTFPIM1, PIM-R1, PIM-R₂, PIM-R3, PIM-R₄, PIM-R5, PIM-R₆, PIM-R7, PIM-PI-1, PIM-PI-2, PIM-PI-3, PIM-PI-4, PIM-PI-7, PIM-PI-8, P4, 6FDA-m4, 6FDA-m3, PIM-6FDA-OH, and PIM-PMDA-OH. Others PIMs and microporous materials other than PIMs can be utilized here without departing from the scope of the present invention.

In some embodiments, the electrode separator can be characterized by nanometer or sub-nanometer sized features that provide the electrode separator with particular properties that can enhance the performance of a battery or electrochemical cell. For example, the electrode separators can have a permanent porosity, high surface area and appropriate chemical, thermal and physical stability suitable of use in a battery or electrochemical cell. In embodiments, enclathrated or encapsulated guest molecules or ions can undergo guest exchange with other molecular or ionic species in the electrode separator to alter or modify properties of the separator. Examples of such species include, but are not limited to, Li⁺, Na⁺, K⁺, Mg²⁺, and the like. The surface area may be determined by using the BET method (“BET surface area”). This refers to the Brunauer, Emmett and Teller (BET) method for surface area determination, which utilizes the isothermal adsorption of nitrogen to measure total surface area of a material. Another method uses the Langmuir model. Thermal stability can be determined using differential scanning calorimetry (DSC), differential thermal analysis (DTA), or thermogravimetric analysis (TGA). Porosity can be determined by porosimitry measurements.

The electrode separator can include designable and tunable pore sizes, pore distribution, and pore shape. In certain embodiments, the electrode separator can include designable and tunable pore functionality. For example, accessible voids inside the porous material can incorporate a variety of guest molecules, ions or gases of desirable functionality for the electrode separator. In certain embodiments, the electrode separator can include a designable and tunable composition of the organic/inorganic parts of the separator, which can provide control and enhancement in the design and selection of suitable material specific electrochemical systems. In certain embodiments, the electrode separator can have a neutral or framework (cationic or anionic), which in the presence of encapsulated/enclathrated counterions can provide control and enhancement in the design and selection of suitable material specific electrochemical systems. The high crystallinity of the electrode separator enables accurate structural characterization and control of desirable properties including ion conductivity, ion exchange, or void dimensions.

In some embodiments, the electrode separator can be characterized by channels/cages/windows having a in diameter in the range of about 0.1 nm to about 20 nm, preferably about 0.5 nm to about 5 nm, and/or a surface area in the range of 1 m²/g to 500 m²/g or more. The electrode separator can exhibit favorable thermal stability in the range of about 100° C. to about 500° C., preferably in the range of about 200° C. to about 300° C. and chemical stability against structural disintegration in neutral, acidic, or basic solutions.

The electrode separator can be thick enough to reduce or eliminate shorting between the positive electrode and the negative electrode by impedance or by preventing electrode dendrite formation. The electrode separator can also allow for facile ion migration between the positive electrode and the negative electrode. For example, the pore size in the electrode separator can be small enough to avoid formation of dendrites through the membrane, but can also be large enough to permit ion migration. The impedance of the electrode separator can be high enough to prevent electrical shorting between the positive electrode and the negative electrode, while optimizing the efficiency of the battery or electrochemical cell. For example, the average pore diameter of the electrode separator can be less than 20 nm, less than 10 nm, less than 5 nm, less than 1 nm, or greater than 0.5 nm, or any incremental range or value thereof (e.g., about 5 nm to about 10 nm, etc.). The average thickness of the electrode separator can be less than 500 microns 100 microns, less than 50 microns, less than 10 microns, less than 1 micron, less than 500 nm, less than 200 nm, less than 100 nm, less than 50 nm, less than 40 nm, less than 30 nm, less than 20 nm, less than 10 nm, less than 5 nm, less than 1 nm, or greater than 0.5 nm, or any incremental value or range thereof (e.g., about 200 microns to about 300 microns, etc.)

A thickness of the electrode separator can be in the range of about 100 nm or greater. In some embodiments, the electrode separator has a thickness of about 100 nm or greater, about 500 nm or greater, about 1 micron or greater, about 10 microns or greater, about 50 microns or greater, about 100 microns or greater, about 500 microns or greater, or any increment or value thereof.

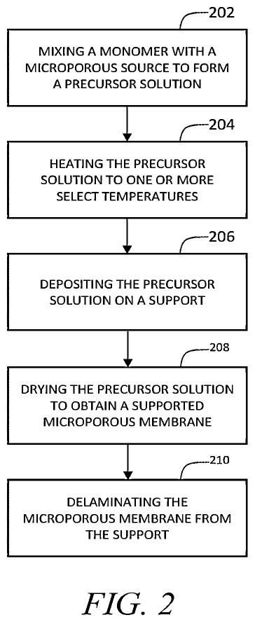

FIG. 2 is a flowchart of a method of making an electrode separator, in accordance with one or more embodiments of the present invention. The method 200 can be used to fabricate electrode separators comprising a freestanding microporous membrane or a freestanding microporous think film, and a threading polymer associated with the freestanding microporous membrane or freestanding microporous thin film via one or more non-covalent interactions. In some embodiments, the method 200 can proceed in a one-pot in situ synthesis. In some embodiments the method 200 includes a solvo(hydro) thermal synthetic procedure. As shown in FIG. 2, the method 200 can include mixing 202 a monomer with a microporous source to form a precursor solution, heating 204 the precursor solution to one or more select temperatures, depositing 206 the precursor solution on a support, drying 208 the precursor solution to obtain a supported microporous membrane, and delaminating 210 the microporous membrane from the support to obtain an electrode separator, the electrode separator including a freestanding microporous membrane and a threading polymer, wherein the threading polymer associates with the freestanding microporous membrane via a non-covalent interaction.

The mixing step 202 can include combining reactants. The mixing can be performed by mechanical mixing, agitating, and/or stirring. In some embodiments, the reactants include precursors for the threading polymer and microporous membrane. The precursors can include any of the microporous materials, polymeric materials, precursors of the microporous material, and/or precursors of the polymeric materials disclosed herein. In some embodiments, the precursor for the threading polymer includes a monomer. In some embodiments, the precursor for the microporous membrane includes precursors for metal-organic frameworks. For example, in some embodiments, precursors for metal-organic frameworks include a first metal source, an optional second metal source, a ligand source, a solvent, and an acid solution. The first and second metal sources can include any of the metals disclosed herein. The metals can be in elemental form, or in the form of ions, nitrates, hydrated nitrates, chlorides, hydrated chlorides, fluorides, hydrated fluorides, oxides, hydrated oxides, and combinations thereof. The solvent can include, for example and without limitation, H₂O, DMF, and DEF. In some embodiments, the acidic solution is a fluorohydric solution, among others.

In some embodiments, the precursor for the microporous membrane includes precursors for covalent organic frameworks. For example, in some embodiments, two or more of the following are selected to be the precursors for the covalent organic framework.

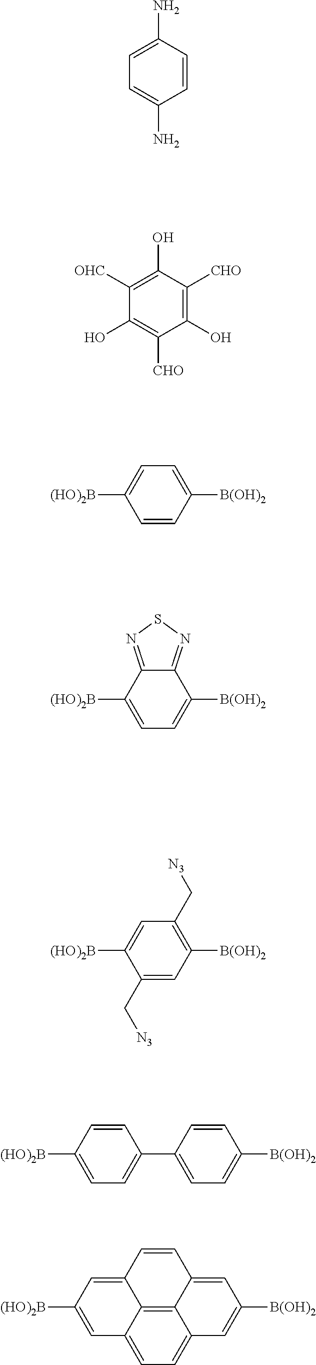

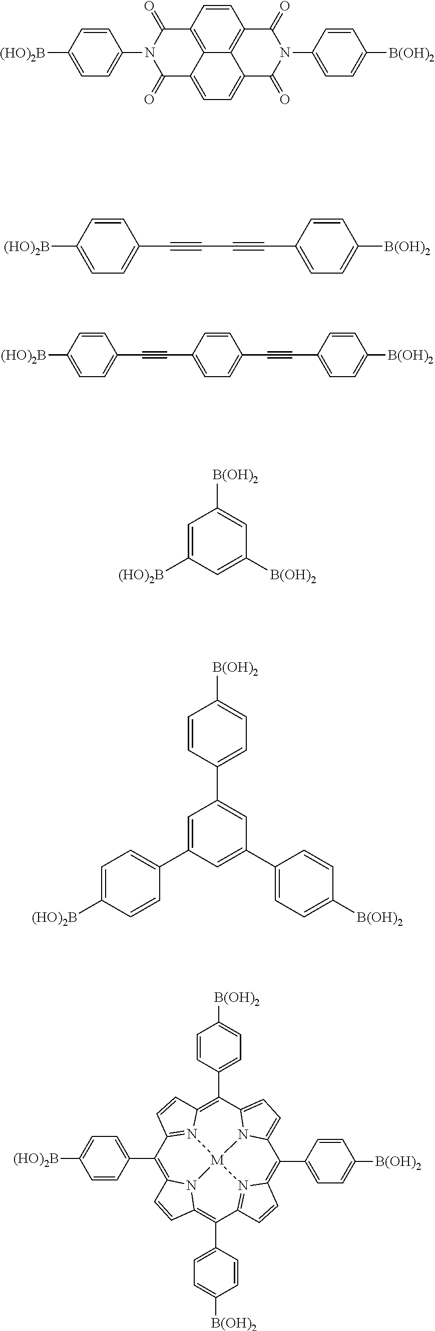

wherein M is Zn, Cu, Hz, TDHB-ZnP, TDHB-CuP, or TDHB-H₂P;

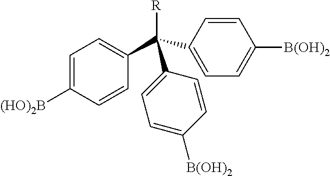

wherein R is an allyl, C₁ to C₁₂ alkyl, or 1,1,1-tris(4-phenyl boronic acid)but-3-ene;

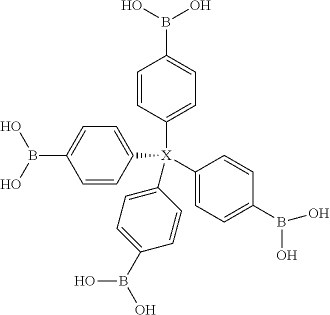

wherein X is C, Si, TBPM, or TBPS;

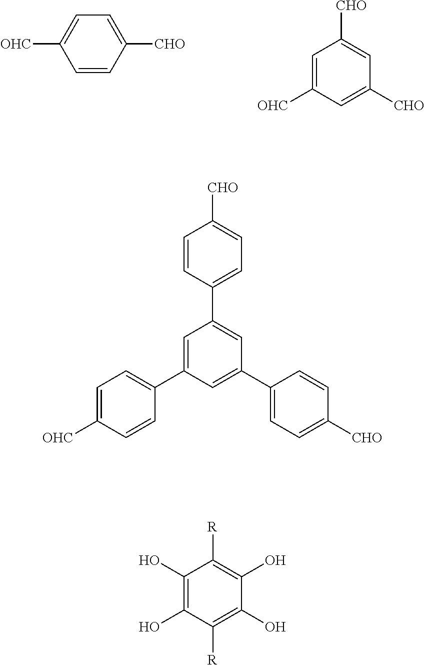

wherein each R is independently hydrogen; C₁ to C₈ alkyl, or 3,6-dimethyl-1,2,4,5-tetrahydroxybenzene;

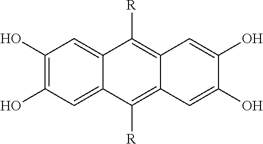

wherein each R is independently hydrogen, C₁ to C₈ alkyl, THAn, or THDMA

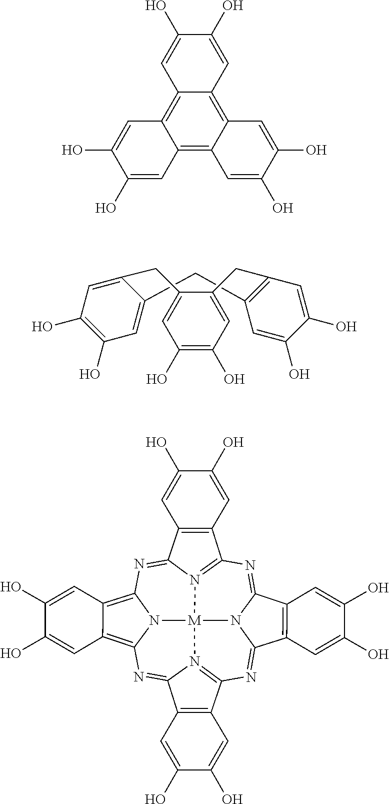

wherein M is Ni, Zn, ZnPc, or [(OH)₈PcNi];

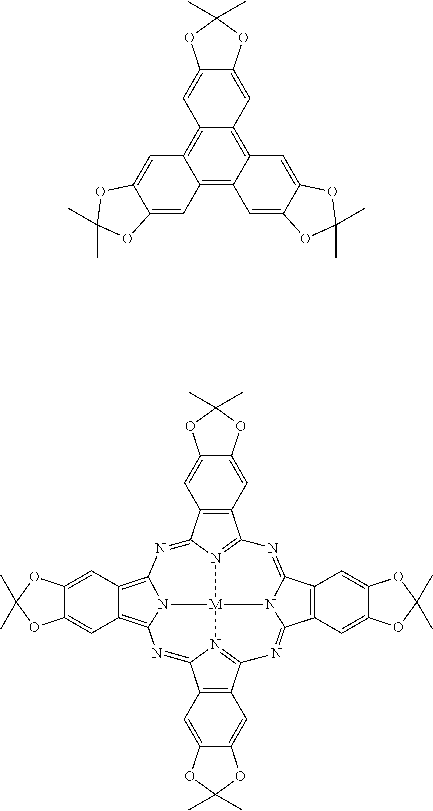

wherein M is H₂, Ni, NiPc tetrakis(acetonide), or phthalocyanine tetra(acetonide);

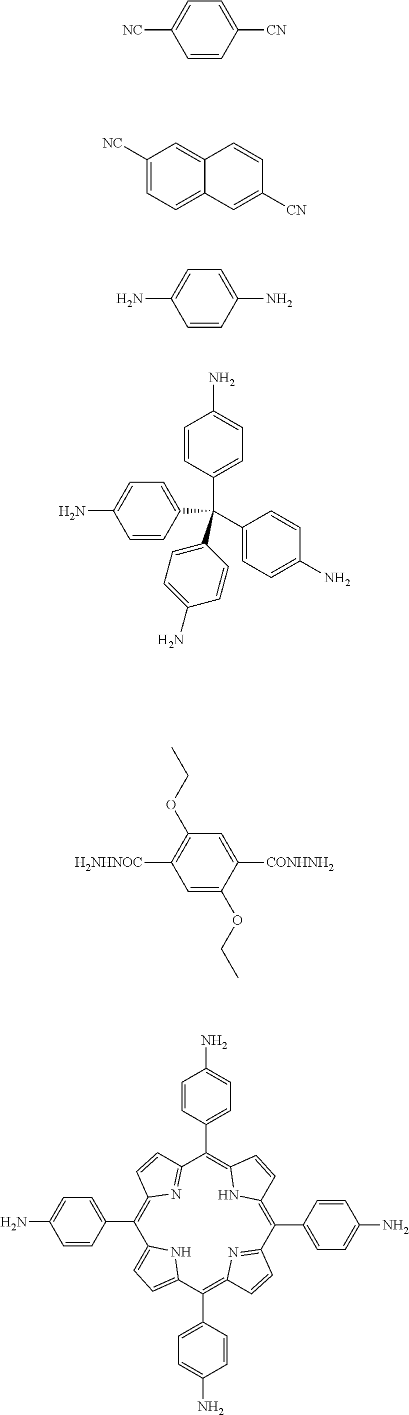

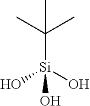

The heating step 204 can include heating the precursor solution to or at a temperature in the range of about 80° C. to about 200° C., or any incremental value or subrange between that range, inclusive. After the heating step 204, the precursor solution can be deposited 206 on any suitable support by spin coating, drop casting, and the like. Once deposited, the precursor solution can be dried 208 to obtain a supported microporous membrane. The drying can proceed under ambient conditions, with heating, evaporating, and the like. Once dried, the now dry and supported microporous membrane can be immersed in a solvent to delaminate the microporous membrane from the support to obtain the electrode separator. The electrode separator can include a freestanding microporous membrane and a threading polymer, wherein the threading polymer associates with the freestanding microporous membrane via a non-covalent interaction. In some embodiments, the method 200 further includes a processing step (not shown) which can include one or more of filtering the precursor solution, rinsing the precursor solution with water, removing excess reactants from the precursor solution, and optionally evacuating guest molecules, such as solvent guest molecules.

In one embodiment, the polymer precursor includes p-toluenesulfonic acid and polystyrene sulfonate. In one embodiment, the COF precursor includes an amine and 2,4,6-trihydroxybenzene-1,3,5-tricarbaldehyde.

Embodiments further include methods of making crosslinked microporous membranes, in accordance with one or more embodiments of the present invention. For example, in some embodiments, the method includes reacting a first precursor and a second precursor to form a microporous material and modifying the microporous material with functional groups that crosslink the microporous material to produce a crosslinked microporous membrane. Any functional group, including any of those disclosed herein, which is or are capable of crosslinking the microporous material can be used herein. In some embodiments, the functional group includes at least one of the following moieties: —NH₂, —OH, —COOH, —SO₃H, and —PO₃H₂.

While any of the microporous materials disclosed herein can be used, in some embodiments, the microporous material includes a polymer of intrinsic microporosity. For example, in some embodiments, the microporous material is a polymer of intrinsic microporosity (PIM) and the PIM is formed by reacting at least one of the following precursors:

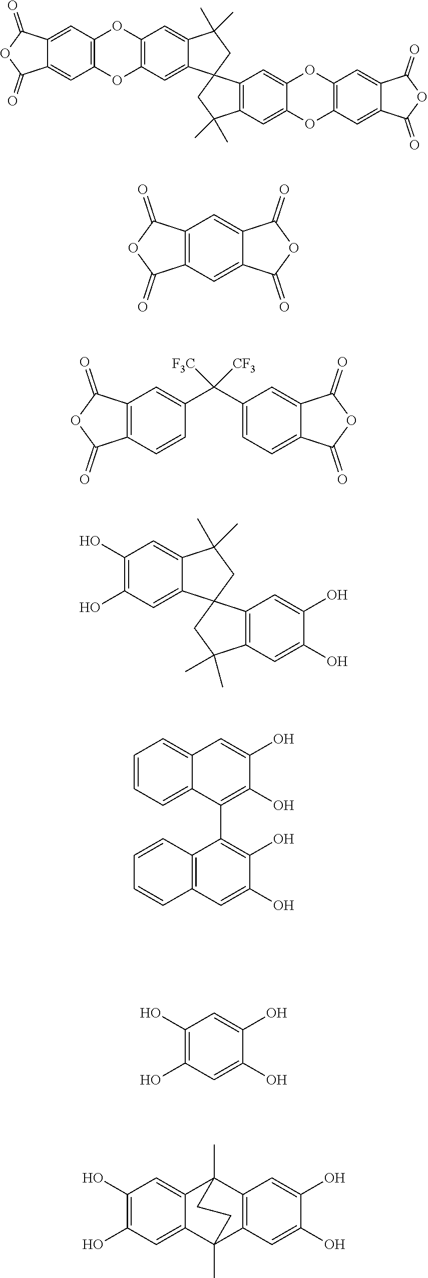

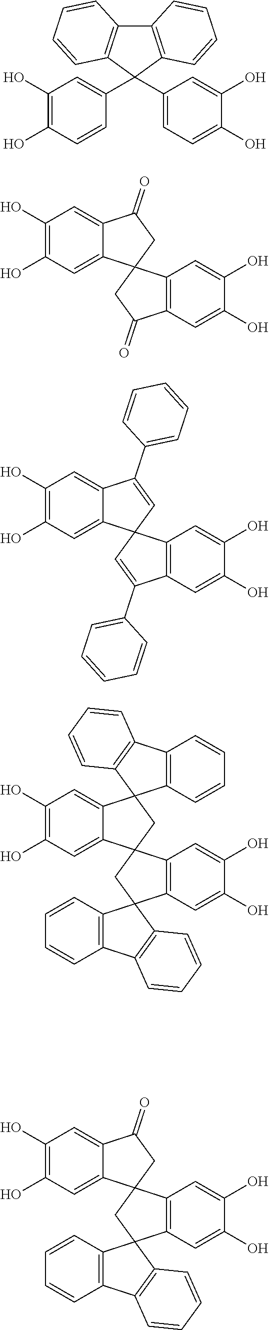

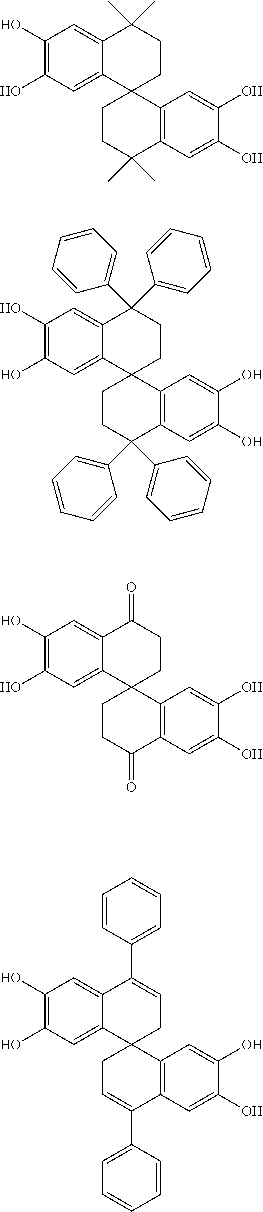 [SMILES: CC1(C)CCC2(CCC(C)(C)c3cc(O)c(O)cc32)c2cc(O)c(O)cc21 ; Oc1cc2c(cc1O)C(c1ccccc1)(c1ccccc1)CCC21CCC(c2ccccc2)(c2ccccc2)c2cc(O)c(O)cc21 ; O=C1CCC2(CCC(=O)c3cc(O)c(O)cc32)c2cc(O)c(O)cc21 ; Oc1cc2c(cc1O)C1(CC=C2c2ccccc2)CC=C(c2ccccc2)c2cc(O)c(O)cc21]

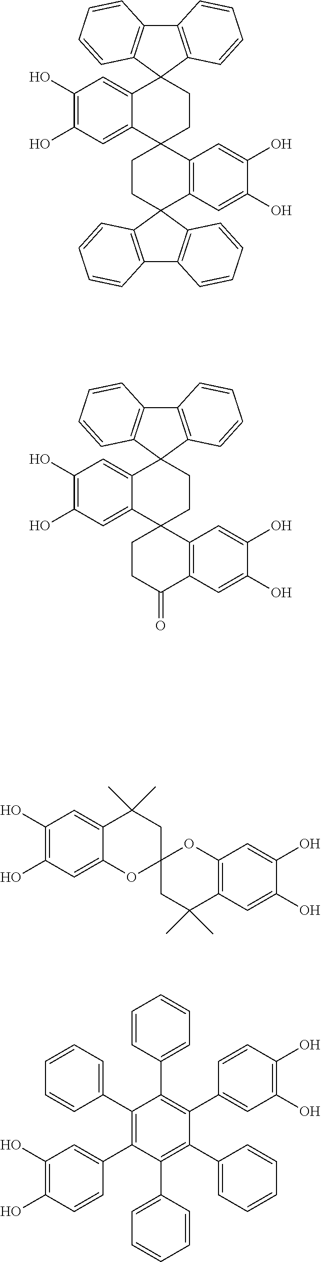 [SMILES: Oc1cc2c(cc1O)C1(CCC23CCC2(c4ccccc4-c4ccccc42)c2cc(O)c(O)cc23)c2ccccc2-c2ccccc21 ; O=C1CCC2(CCC3(c4ccccc4-c4ccccc43)c3cc(O)c(O)cc32)c2cc(O)c(O)cc21 ; CC1(C)CC2(CC(C)(C)c3cc(O)c(O)cc3O2)Oc2cc(O)c(O)cc21 ; Oc1ccc(-c2c(-c3ccccc3)c(-c3ccccc3)c(-c3ccc(O)c(O)c3)c(-c3ccccc3)c2-c2ccccc2)cc1O]

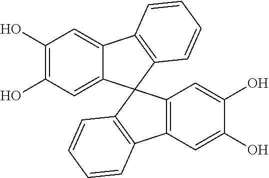 [SMILES: Oc1cc2c(cc1O)C1(c3ccccc3-2)c2ccccc2-c2cc(O)c(O)cc21]

with at least one of the following precursors:

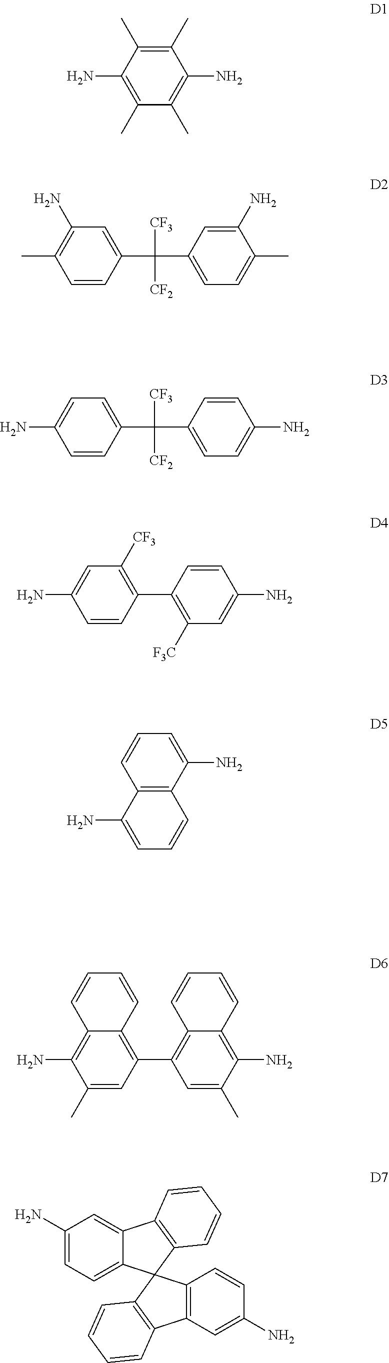

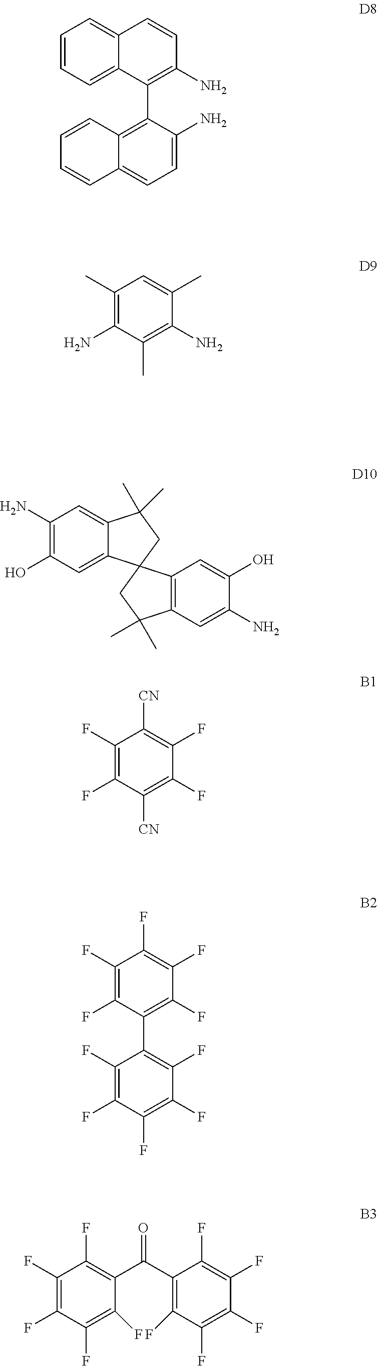

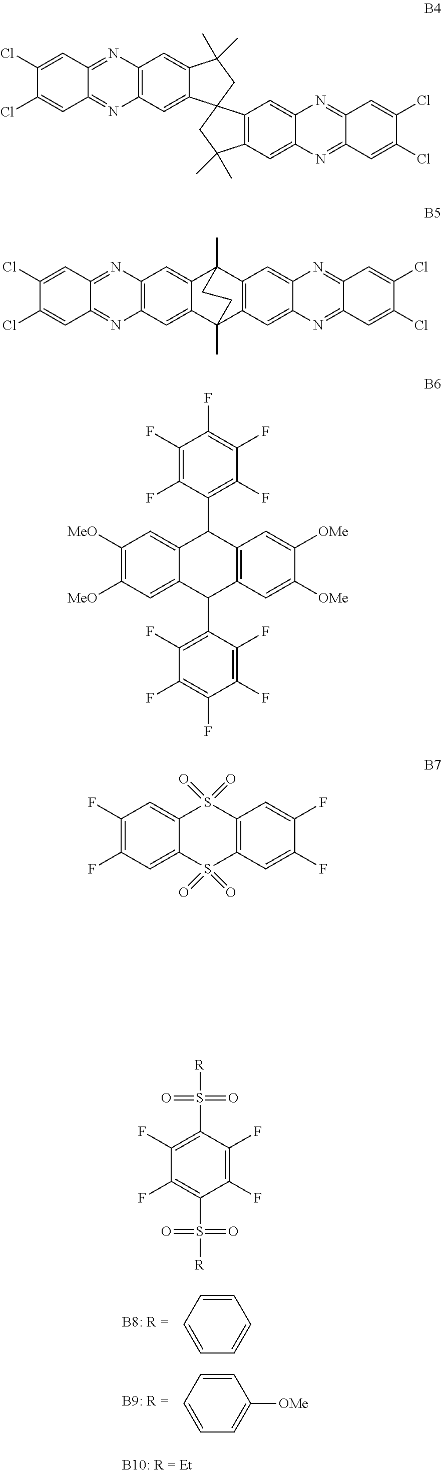

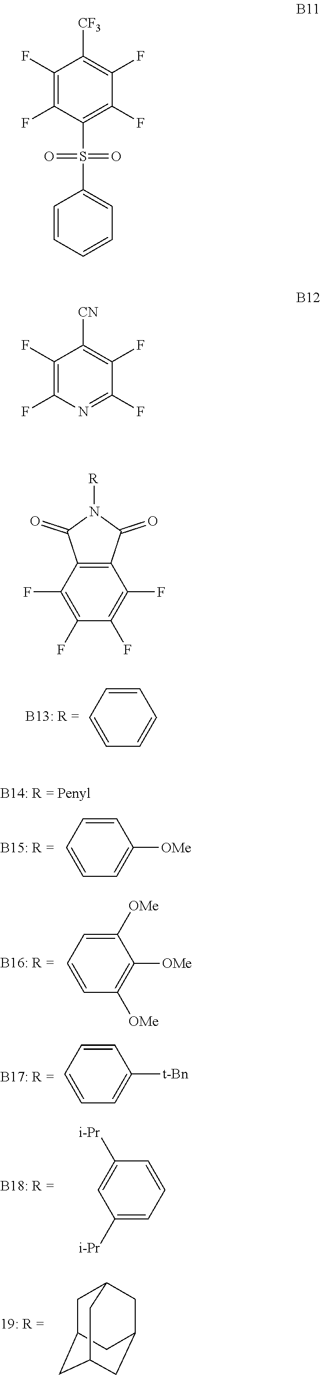

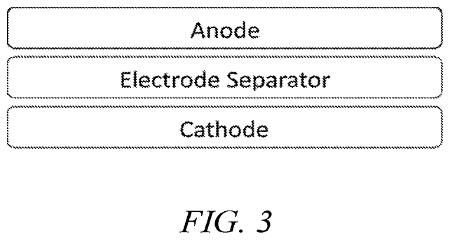

Referring to FIG. 3, a battery and/or electrochemical cell is provided, according to one or more embodiments of the present disclosure. As shown, the battery and/or electrochemical cell can include a first layer, a second layer, and a third layer disposed between the first layer and second layer. The first and/or second layer can include an anode material and/or a cathode material, and the third layer can include any of the electrode separators disclosed herein. For example, in embodiments, a battery or electrochemical cell is provided comprising a first layer comprising an anode material, a second layer comprising a cathode, and a third layer comprising an electrode separator, wherein the third layer is disposed between the first and second layers, and wherein the electrode separator comprises a freestanding microporous membrane associated with a threading polymer through one or more non-covalent interactions. The battery and/or electrochemical cell can further comprise a housing (not shown) enclosing or containing the anode, cathode, and/or electrode separator. Any suitable housing can be utilized herein and thus is not particularly limited.

The battery and electrochemical cell can include a primary cell or non-rechargeable battery or a secondary cell or rechargeable battery. Examples of a primary cell include, but are not limited to, an alkaline battery, aluminum battery, chromic acid cell, Clark cell, Daniell cell, dry cell, Earth battery, Galvanic cell, Grove cell, Leclanché cell, lithium battery, lithium air battery, mercury battery, molten salt battery, nickel oxyhydroxide battery, oxyride battery, organic radical battery, paper battery, Pulvermacher's chain reserve battery, silver-oxide battery, solid-state battery, voltaic pile, penny battery, trough battery, water-activated battery, Weston cell, zinc-air battery, zinc-carbon battery, or zinc chloride battery. Examples of a secondary cell include, but are not limited to, a flow battery, vanadium redox battery, zinc-bromine flow battery, fuel cell, lead-acid battery, deep cycle battery, VRLA battery, AGM battery, gel battery, lithium air battery, lithium-ion battery, Beltway battery, lithium ion polymer battery, lithium iron phosphate battery, lithium-sulfur battery, lithium-titanate battery, molten salt battery, nickel-cadmium battery, nickel-cadmium battery, vented cell type nickel hydrogen battery, nickel-iron battery, nickel metal hydride battery, low self-discharge NiMH battery, nickel-zinc battery, organic radical battery, polymer-based battery, polysulfide bromide battery, potassium-ion battery, rechargeable alkaline battery, silicon air battery, sodium-ion battery, sodium-sulfur battery, super iron battery, zinc-bromine flow battery, or zinc matrix battery. In some embodiments, a lithium ion battery comprising the electrode separator is provided. In some embodiments, a sodium ion battery comprising the electrode separator is provided. In some embodiments, a zinc ion battery comprising the electrode separator is provided.

The first and/or second layer can be or include a substrate and can be one electrode of the battery or the electrochemical cell. The substrate can be or include any solid support, for example, a porous, conductor, semi-conductor, magnetic, metallic, non-metallic, photoactive, polymer, or heat responsive material. The substrate can be conducting, semiconducting or insulating. The substrate can be quartz, diamond, silica, alumina, a metal oxide, a metal hydroxide, a metal salt, a metal in elemental state, a metal of any valency, a metalloid, an alloy, or other suitable material. The substrate can be amorphous, polycrystalline, or a single crystal. The substrate surface can be in contact with the third layer (e.g., the electrode separator) and can have a polished, rough, patterned, or functionalized surface, for example, with surface-active molecules (SAMs). Each of the first layer and second layer can independently include metals, metal oxides, metal salts, metal complexes, metalloid, metal or metalloid nanoparticles, molten salts or gasses. The first layer can be complementary to the second layer. For example, in some embodiments, the first layer is or comprises an anode material and the second layer is or comprises a cathode material. In other embodiments, the first layer is or comprises a cathode material and the second layer is or comprises an anode material.

The third layer can include the electrode separator. The electrode separator can be transferred to, deposited, or disposed on the first layer and/or second layer, such as a first electrode of a battery or electrochemical cell. For example, the electrode separator can transferred as a freestanding microporous thin film or membrane to an anode and/or cathode. The electrode separator can be selected from any of the electrode separators of the present disclosure. For example, the electrode separator can be any MOF, COF, PIM, MOP, CP, etc. of desirable structure or functionality. The electrode separator can form chains, sheets, or a 3D polymer or crystalline network. In addition, the electrode separator can be neutral, anionic, or cationic and can include different counterions, combining any one or more metals, transition metals, lanthanides, alkaloids, rare-earth metals, chalcogenides, and one or more organic molecules as linker. In certain embodiments, the electrode separators can include accessible voids inside the structure, which can be unoccupied or occupied by guest molecules such as solvents, organic substances, counterions, ionic species, gases, or other species. The dimension and chemical composition of the electrode separator along with the nature of optional enclosed guest molecules or ions can provide control over ion migration characteristics through the separator, thus enabling enhancement and/or control of the battery or electrochemical cell performance.

Each of the anode or cathode can be fabricated through a variety of techniques such as pressing from powder, chemical or electrical plating or deposition, spray deposition, monolith, sputtering, or casting. The electrode separator can be transferred as a freestanding membrane or thin film to one or more of the first layer and second layer. The electrode separator, such as MOF, COF, PIM, MOP, CP, can also be deposited or disposed on one or more of the first layer and second layer through solvothermal syntheses, spraying, dry grinding, vapor deposition, pellets pressing, or printing. The electrode separator can be deposited as a mixture with other ingredients in the form of composite material. The electrode separator can include a MOF, COF, PIM, MOM, CP supported inside cavities or channels of a gel, a sol-gel, a porous inorganic support, or an organic polymer.

The following Examples are intended to illustrate the above invention and should not be construed as to narrow its scope. One skilled in the art will readily recognize that the Examiners suggest many other ways in which the invention could be practiced. It should be understood that numerous variations and modifications may be made while remaining within the scope of the invention.

### Example 1

### Freestanding COF Membrane Threaded with Polystyrene Sulfonate

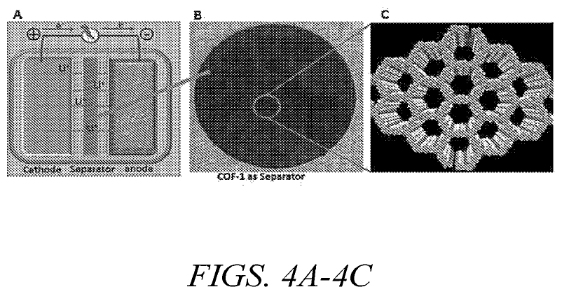

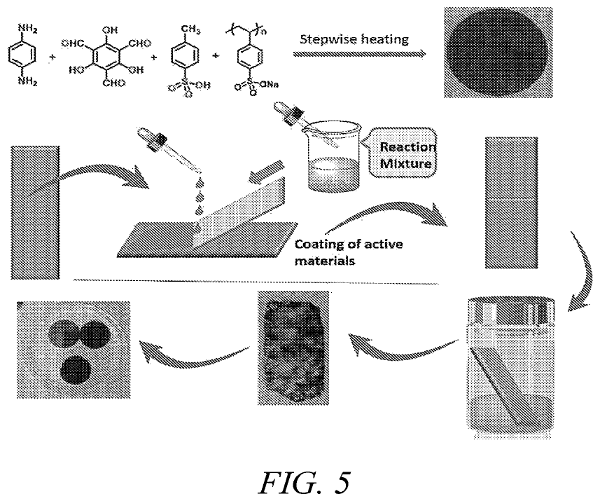

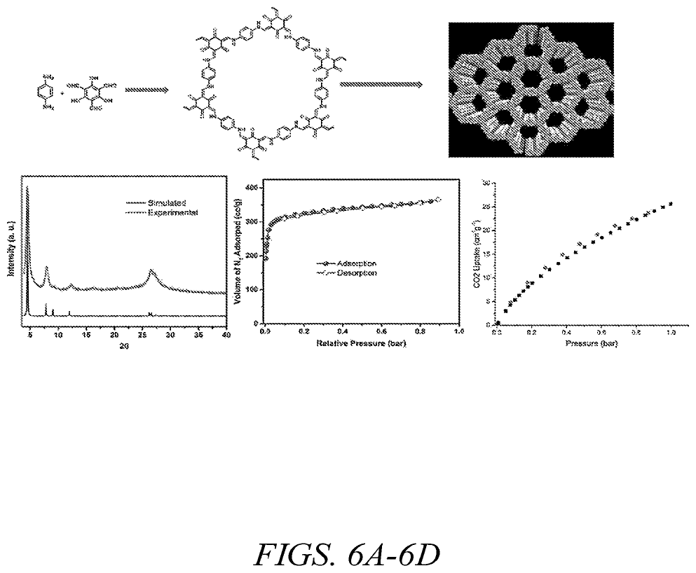

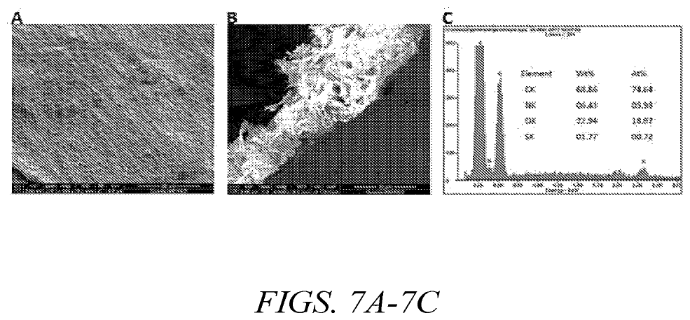

The following Example describes a new method relating to a one-pot in-situ synthesis of freestanding porous membranes (e.g., COF membranes or MOF membranes) threaded with polystyrene sulfonate (FIGS. 4A-4C, 5). The method utilized a water-soluble polymer and stable layer COF to obtain the membrane. The method is not limited by the Example provided herein. For example, different amines and water-soluble polymers, among others, may also be used. For the first time, the membrane was used to test its usage as a lithium ion battery and lithium sulfur battery separator. The COF can be found in the membrane which is demonstrated by different methods of characterization like PXRD, SEM and EDX (FIGS. 6A-6D, 7A-7C). The COF and the polymer were clearly mixed homogeneously in the membrane by using SEM. EDX results show that the S elements, which belong to the polymer, and the N elements, which belong to the COF, both exist in the membrane. After solvent wash, the polymer and COF did not leak out and break. The N₂ adsorption isotherm shows that the membranes are highly porous FIG. 6C. Applying this membrane in the battery cell proved to be successful, demonstrating its wide potential as a separator, among other things. While not wishing to be bound to a theory, it is believed that the COF membrane and polystyrene sulfonate associated according to scheme 1 below (dashed lines represent hydrogen bonding):

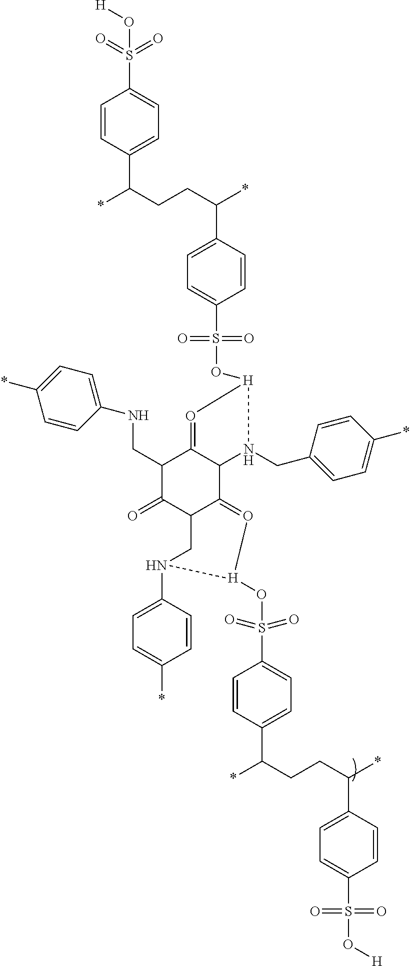

### Example 2

### Freestanding Crosslinked PIM Membranes

The following Example presents a method in which a polymer of intrinsic microporosity is fabricated according to the reaction scheme presented below:

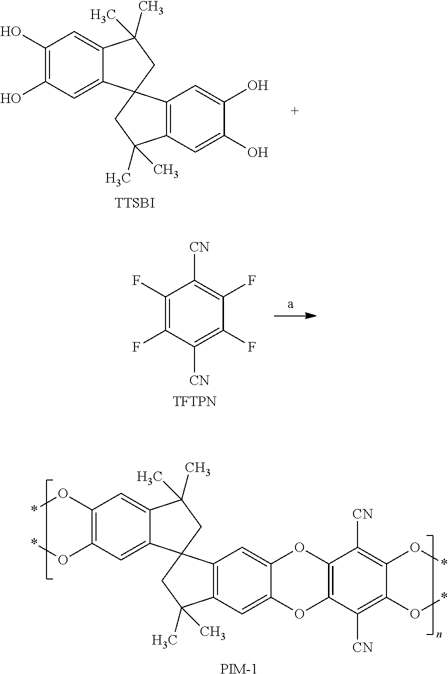

The PIM-1 is then modified post-synthesis to include functional groups that crosslink the material and yield a freestanding crosslinked PIM membrane in accordance with the reaction scheme presented below:

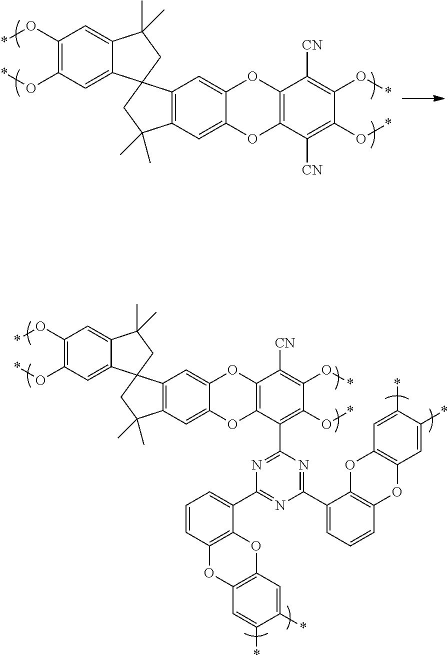

### Example 3

### Freestanding Crosslinked PIM Membranes

The following Example presents a method in which a polymer of intrinsic microporosity is fabricated according to the reaction scheme presented below:

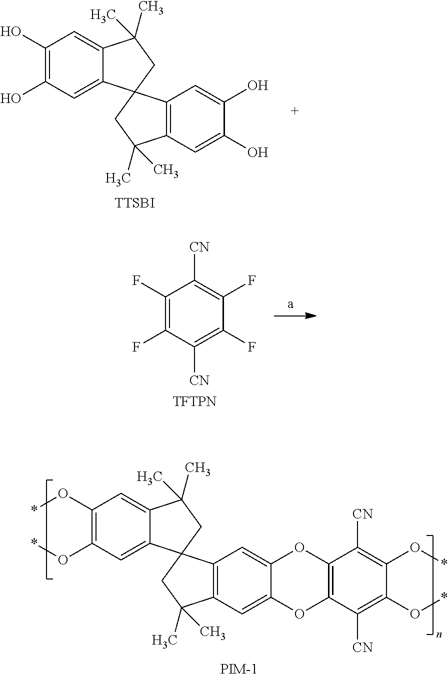

The PIM-1 is then modified post-synthesis to include functional groups that crosslink the material and yield a freestanding crosslinked PIM membrane in accordance with the reaction scheme presented below:

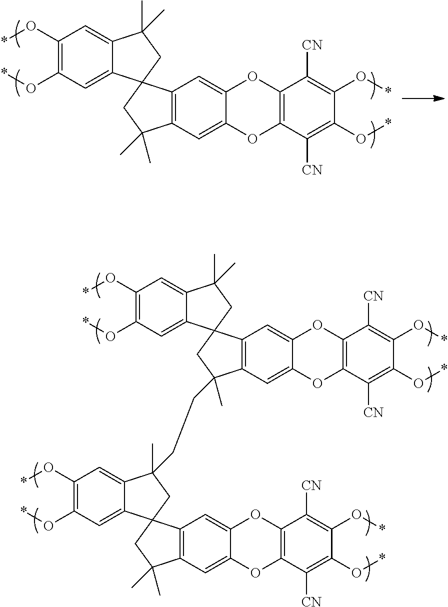

### Example 4

### Freestanding MOF Membrane

Similar to the COF membrane described in EXAMPLE 1, MOFs are of great interest for their unique properties, such as high porosity, high surface area, tunable pore size and functionality. As a result of these properties, they can be used as a membrane/separator in Li—S ion battery to control the diffusion of ions and significantly reduce the polysulfide migration.

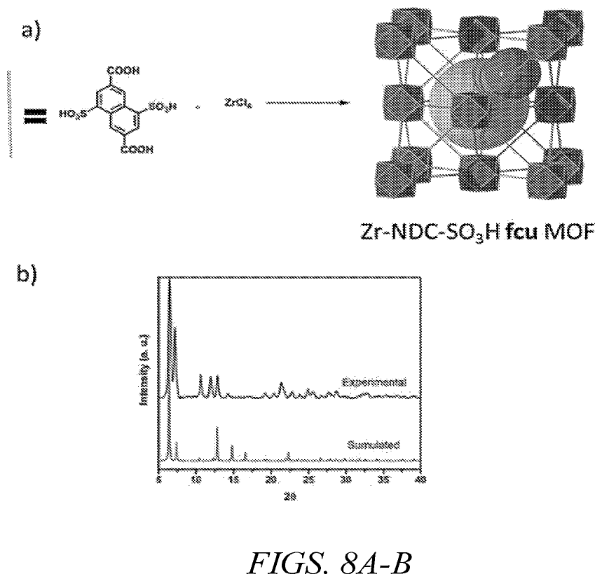

This example describes an SO₃H functionalized Zr-NDC-fcu based MOF application as a separator for Li—S ion battery. The material was synthesized (FIG. 8A) and structure confirmed and later fully characterized using different techniques, such as PXRD (see FIG. 8B).

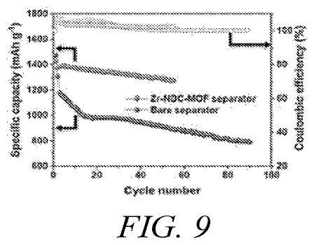

Additionally, the performance of the MOF as a separator was tested in a battery cell using Li as the anode, 1 M Lithium bis(trifluoromethane)sulfonamide and 0.4 M LiNO₃ in DME and Dioxolane as electrolyte. The MOF showed a superior cycling performance as a separator compared to the commercial Celgard separator for the Li—S battery (FIG. 9). This demonstrate the feasibility for the application of MOFs as separators for ion batteries.

Other embodiments of the present disclosure are possible. Although the description above contains much specificity, these should not be construed as limiting the scope of the disclosure, but as merely providing illustrations of some of the presently preferred embodiments of this disclosure. It is also contemplated that various combinations or sub-combinations of the specific features and aspects of the embodiments may be made and still fall within the scope of this disclosure. It should be understood various features and aspects of the disclosed embodiments can be combined with or substituted for one another in order to form various embodiments. Thus, it is intended that the scope of at least some of the present disclosure should not be limited by the disclosed embodiments described above.

Thus, the scope of this disclosure should be determined by the appended claims and their legal equivalents. Therefore, it will be appreciated that the scope of the present disclosure fully encompasses other embodiments which may become obvious to those skilled in the art, and that the scope of the present disclosure is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

The foregoing description of various preferred embodiments of the disclosure have been presented for purposes of illustration and description. It is not intended to be exhaustive or to limit the disclosure to the precise embodiments, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. It is intended that the scope of the disclosure be defined by the claims appended hereto

Various examples have been described. These and other examples are within the scope of the following claims.

1. An electrode separator, comprising:
a freestanding microporous membrane including at least one of a covalent organic framework and a metal-organic framework, and
a threading polymer associated with the freestanding microporous membrane via one or more non-covalent interactions or via crosslinking,
wherein each of the threading polymer and freestanding microporous membrane include at least one moiety that participates in the one or more non-covalent interactions.

2. The electrode separator according to claim 1, wherein the threading polymer includes one or more of polystyrene sulfonate, polycarboxylic acids, polyvinyl alcohols, polyethers, polyketones, polyaldehydes, polyacrylamides, polyethylene glycols, polyamines, polyethyleneimines, polyphosphazenes, quaternary ammonium polymers, and polysaccharides.

3. The electrode separator of claim 1, wherein the non-covalent interaction includes hydrogen bonding.

4. The electrode separator according to claim 3, wherein the threading polymer includes a hydrogen bond donor moiety and the freestanding microporous membrane includes a hydrogen bond acceptor moiety.

5. The electrode separator according to claim 3, wherein the threading polymer includes a hydrogen bond acceptor moiety and the freestanding microporous membrane includes a hydrogen bond donor moiety.

6. The electrode separator of claim 4, wherein the hydrogen bond donor moiety is —O—H, —N—H, —P—H, —S—H, ≡C—H, —C(═O)—H, or —C(E₁E₂)-H, where E₁ and E₂ are each independently selected from O, F, Cl, and Br.

7. The electrode separator of claim 4, wherein the hydrogen bond acceptor moiety is —C(═O)—, —N(H)—, —O(H)—, —C(F)—, —P(═O)—, —C≡N, —C—O—, —C═N—, —C—NO₂, or —C—SO₃H.

8. The electrode separator of claim 1, wherein the non-covalent interaction includes electrostatic dipole-dipole interaction.

9. The electrode separator according to claim 8, wherein the threading polymer and freestanding microporous polymer each independently include a polar moiety selected from the group consisting of hydroxyl, carboxyl, carbonyl, ester, ether, amine, thiol, halogen, sulfone, phosphate, sulfonamide, and carbonate.

10. The electrode of claim 1, wherein the electrode separator comprises less than about 20% threading polymer by weight.

11. A lithium ion battery, a sodium ion battery, or a zinc ion battery comprising the electrode separator of claim 1.

12. An electrochemical cell, comprising: a first electrode, a second electrode, and an electrode separator of claim 1, wherein the electrode separator is disposed between the first electrode and second electrode.

13. A method of fabricating an electrode separator comprising:
reacting a first PIM precursor and a second PIM precursor to form a PIM; and
modifying the PIM with a functional group that crosslinks the PIM to produce a freestanding crosslinked PIM membrane, wherein PIM is a polymer of intrinsic microporosity and wherein the functional group is at least one of the following: —NH2, —OH, —COOH, —SO3H, and —PO3H2.

14. An electrochemical cell comprising an electrode separator fabricated according to the method of claim 13.

15. A lithium ion battery, a sodium ion battery, or a zinc ion battery comprising the electrode separator of claim 13.

16. A method of fabricating an electrode separator, comprising:
mixing a polymer precursor with a microporous precursor to form a precursor solution,
heating the precursor solution to one or more select temperatures;
depositing the precursor solution on a support;
drying the precursor solution to obtain a supported microporous membrane; and
delaminating the microporous membrane from the support to obtain an electrode separator, the electrode separator including a freestanding microporous membrane and a threading polymer, wherein the threading polymer associates with the freestanding microporous membrane via a non-covalent interaction.

17. The method according to claim 16, wherein the polymer precursor includes monomers having at least one of the following: hydrogen bond donor moiety, hydrogen bond acceptor moiety, and polar moiety.

18. The method of claim 16, wherein the microporous precursor includes a metal-organic framework precursor, the metal organic framework precursor having at least one of the following: hydrogen bond donor moiety, hydrogen bond acceptor moiety, and polar moiety.

19. The method of claim 16, wherein the microporous precursor includes a covalent organic framework precursor, the covalent organic framework precursor having at least one of the following: hydrogen bond donor moiety, hydrogen bond acceptor moiety, and polar moiety.

20. The method of claim 16, wherein the method includes at least one or more of the following:
(a) the select temperature ranges from about 80° C. to about 200° C.;
(b) the depositing includes drop casting or spin coating; and
(c) the delaminating includes immersing the supported microporous membrane in a solvent.
